(19) United States
(12) Patent Application Publication
(10) Pub. No.: US 2017/0083963 A1
(43) Pub. Date: Mar. 23, 2017

(54) METHODS AND SYSTEMS FOR PROVIDING GIFT RECOMMENDATIONS

(71) Applicant: Rovi Guides, Inc., Santa Clara, CA (US)

(72) Inventor: Akshat Agarwal, Delhi (IN)

(21) Appl. No.: 14/858,895

(22) Filed: Sep. 18, 2015

(51) Int. Cl. G06Q 30/06; G06Q 50/00; G06F 17/30

(52) U.S. Cl. CPC G06Q 30/0631; G06Q 30/0633; G06F 17/30864; G06F 17/30528; G06F 17/30976; G06F 17/3053; G06Q 50/01

(57) ABSTRACT

Systems and methods for providing a curated list of gift recommendations for users without querying the users or publicly disclosing information about the users. The systems and methods may identify a list of recommended gifts that share a particular attribute provided by a first user. By comparing the list of recommended gifts with a user profile for a second user to determine a weighting for each gift, and filtering the list based on the weightings, the first user may be provided with a curated list of gift recommendations customized for the second user, without the need to fully access the second user's profile.

### BACKGROUND

In conventional online systems, users can either make a wish list for gifts they would like to receive, or they can publically share some information about the types of gifts they would like to receive. However, this means a person trying to buy a gift for a friend or loved ones is forced into either selecting an item from the wish list, or guessing about what item a user may enjoy based on limited public information. Furthermore, asking a friend what that friend would like to receive as a gift may not be appropriate in all circumstances (e.g., if the person wishes to surprise the friend). Thus, a friend may be forced to purchase a boring, predictable gift chosen from a list, or risk the possibility that the recipient either already owns the gift or completely hates the gift.

### SUMMARY

Accordingly, methods and systems are described herein for providing a curated list of gift recommendations for users without querying the users or publicly disclosing information about the users. For example, in order to relieve a gift giver from having to ask a gift recipient what the gift recipient would like and in order to prevent a gift recipient from having to publicly disclose his/her gift preferences, the media guidance application may generate gift recommendations for a gift giver based on privately held gift preferences for the gift recipient. For example, the media guidance application may access information on the gift recipient that is not publically available and provide gift recommendations to the gift giver.

Additionally, in order to customize the gift to the gift recipient and/or the circumstances of the gift, the media guidance application may allow a gift giver to select particular criteria for the gift. For example, the media guidance application described herein may identify a list of recommended gifts that share a particular attribute provided by a first user. The media guidance application may then compare each of the recommended gifts with a user profile for a second user to determine a weighting for each gift. The media guidance application may then filter the list of gifts based on the weightings, and present the filtered list of gifts to the first user as a curated list of gift recommendations. Thus the system is able to produce gift recommendations that are personalized to both the gift giver and the gift recipient, while requiring only limited access to the gift recipient's user profile.

Additionally or alternatively, the media guidance application may create a profile for a second user based on publically or privately available information about the second user. For example, the media guidance application may query the first user for information on the likes and/or dislikes of the second user. The media guidance application may use this information to create a user profile. The media guidance application may then supplement the user profile with other information that is publically or privately available. The supplemented profile may then be used to provide gift recommendations.

In some aspects, a media guidance application may receive a request from a first user to provide gift recommendations for a second user, wherein the request comprises a desired gift attribute and an identity of the second user. For example, a first user may want to request a gift recommendation for a friend that has expressed a newfound interest in fly-fishing. In this scenario, the media guidance application may receive a request for gifts with the attribute “related to fly-fishing,” along with the identity of the friend.

In some embodiments the media guidance application may receive the identity of the second user in the form a name, a pseudonym, such as a username the second user uses online, or a uniform resource locator (URL) associated with the second user, like a link to the second user's social media account. The identity of the second user may also be received in the form of an image, an event, or a location. For example, even if the first user forgets the recipient's name, the media guidance application may receive a request to recommend a gift for a person depicted in a photo, a request to recommended a gift for a person hosting a birthday party, or a request to recommend a gift for a neighbor that lives next-door to the first user.

In some embodiments the media guidance application may receive a list of additional gift attributes. For example, the media guidance application may receive the attributes “historical” and “book” to go along with “related to fly-fishing.” In some embodiments the media guidance application may also receive a list of importance levels, wherein each element in the list of importance levels indicates a level of importance for either the gift attribute or one of the additional gift attributes. For example, the media guidance application may receive a list indicating “related to fly-fishing” is very important, “book” is somewhat important, and “historical” is still desirable, but not very important.

In some embodiments, the media guidance application may generate the gift attribute by applying a natural language processing algorithm to a received string of characters or spoken audio. For example, the media guidance application may receive a request to “recommend something related to fishing for Jim's Fourth of July BBQ.” By applying natural language processing, the media guidance application may identify this as a request for a recommendation, identify “Jim” as the intended recipient, and determine “related to fishing” as the gift attribute.

The media guidance application may then generate a database query from the gift attribute. For example, the media guidance application may generate a database query for a particular gift attribute by formatting the query using the appropriate syntax and application programming interface (API) for the recommendation engine database that will be used. In some embodiments the media guidance application may also generate the query based on multiple gift attributes, or importance levels associated with each gift attribute.

The media guidance application may then transmit the generated query to a recommendation database, the database comprising a list of possible gifts and attributes describing each possible gift. For example, the recommendation database may contain a graph directly linking together different products and attributes describing each product. As another example, the recommendation database may comprise a relational database linking together a gift database and an attribute database.

The media guidance application may then retrieve, from the recommendation database, a list of recommended gifts and attributes describing each recommended gift, wherein each of the recommended gifts is described by the gift attribute. For example, after querying the recommendation database for gifts matching the attribute “related to fly-fishing,” the media guidance application may retrieve a list of recommended gifts including fishing rods, lures, or literature about fly-fishing along with a list of attributes describing each of the gifts. For example, if one of the recommended gifts is the book “History of Fly-Fishing in Fifty Flies,” the list of attributes describing the gift may include “book,” “non-fiction,” “historical,” “author: Ian Whitelaw,” “related to fly-fishing,” “related to outdoor recreation,” “vivid pictures,” and “appropriate for all ages.”

The media guidance application may then identify a user profile associated with the second user based on the identity of the second user, wherein the user profile comprises at least one of a purchase history, a viewing history, and gift attribute preferences. For example, if the media guidance application received the name of the second user in the original request, the media guidance application may use that information to perform a search and identify the second user's profile on popular social media and shopping sites. As an alternate example, the second user may have shared an electronic signature or key with the first user, which may be used by the media guidance application to access a user profile associated with the second user. In yet another example, the user profile may be a sub-profile created by the first user on behalf of the second user, populated with profile information provided by the first user. This sub-profile may be associated with both the first user and the second user, for example, it could be a profile specifically made by Jane for her husband, Jim.

The media guidance application may then determine a weighting for each of the recommended gifts. For example, for each of the recommended gifts, the media guidance application may evaluate the gift using the information contained in the identified user profile, and determine a weighting based on the information available from the user profile.

In some embodiments the media guidance application may also receive an initial weighting for each of the recommended gifts from the recommendation database. For example, the initial weighting may describe how well each of the recommended gifts match the gift attribute used to generate the database query. In some embodiments, the media guidance application may receive this information as a numerical relevance level, wherein the relevance level describes how relevant each attribute is to the recommended gift.

In some embodiments, the media guidance application may determine the weighting by comparing the recommended gift with the purchase history of the second user. For example, for each of the recommended gifts, the media guidance application may see if the recommended gift exists in the purchase history of the second user. If the gift already exists, the media guidance application may reduce the weighting or set the weighting to zero.

In some embodiments, the media guidance application may compare the attributes describing the recommended gift with the gift attribute preferences of the second user. For example, the second user may have a certain set of attributes that they like or dislike.

In some embodiments, the media guidance application may determine a preference level for one of the attributes describing the recommended gift based on the gift attribute preferences of the second user, and modify the weighting based on the determined preference level. For example, if the second user has a high preference for gifts related to “hunting,” “camping,” and “rafting,” the media guidance application may determine that “related to fishing” is also a desirable attribute, and raise the weighting for recommended gifts associated with the “related to fishing” attribute.

In some embodiments, the media guidance application may compare the attributes describing the recommended gift with attributes describing an item contained in the purchase history of the second user. For example, if the purchase history contains several items related to “mysticism,” such as books and memorabilia related to magic, ghosts, and Wicca, the media guidance application may increase the weighting for recommended gifts associated with the “mysticism” attribute.

In some embodiments the media guidance application may identify lists of synonyms and antonyms for attributes describing a recommended gift, and a similar lists of synonyms and antonyms for attributes describing the items contained in the purchase history. The media guidance application may then compare the lists together and modify the weighting based on the comparison. For example, a recommended gift may be associated with the attribute “occult.” The media guidance application may generate a list of synonyms for the “occult” attribute, such as “mystical,” “mysticism,” “spiritual,” and “magical.” If the purchase history contains several items related to the “mysticism” attribute, the media guidance application may increase the weighting for the recommended gift accordingly. In some embodiments, the media guidance application may also include related attributes in the list of synonyms, even if they are not literal synonyms. For example, the media guidance application may include “Spaghetti Western” as a synonym for “Old West Movie.”

In some embodiments, the media guidance application may compare the attributes describing the recommended gift with attributes describing an item contained in the viewing history of the second user. For example, if the recommended gift is a box set for the film “National Treasure,” one of the associated attributes may be “related to Nicolas Cage,” the actor who stars in the film. If the viewing history of the second user contains multiple films also associated with the “related to Nicolas Cage” attribute, the weighting for the recommended gift may be increased. Similarly, if the second user has an extensive viewing history, but nothing in the history is associated with the attribute “related to Nicolas Cage,” the weighting may be reduced.

In some embodiments the media guidance application may identify an additional user profile associated with the first user, wherein the additional user profile comprises at least one of a purchase history and a viewing history. The media guidance application may then determine a second weighting for each of the recommended gifts based on the information in the additional user profile, and modify determined weighting based on the second weighting. For example, if the first user is requesting that the media guidance application provide a gift recommendation for the user's wife, the media guidance application may identify a recommended gift they would both enjoy by determining a weighting based on both the first user's profile and the wife's profile.

The media guidance application may then filter the list of recommended gifts based on the determined weightings, wherein the filtering comprises removing recommended gifts with a weighting below a threshold from the list. For example, the media guidance application may set a threshold of “50” and remove any gift with a weighting below the threshold.

The media guidance application may then provide the filtered list as a curated list of gift recommendations to the first user. For example, the media guidance application may display the list of gift recommendations to the first user.

In some embodiments the media guidance application may also rank the list of recommended gifts by their weighting, and select a predetermined number of the top ranking recommended gifts to be included in the filtered list. For example, the media guidance application may rank the recommended gifts by weighting, and select the six recommended gifts with the highest weightings to be included in the filtered list.

In some embodiments the media guidance application may present part of the filtered list to the user in an order based on their ranking. For example, the media guidance application may display the highest ranking gifts towards to top of the screen, or prominently feature the highest ranking gifts within a mosaic display.

In some aspects, the media guidance application may receive a request from a first user to provide gift recommendations for a second user, wherein the request comprises a gift attribute and an identity of the second user. For example, a first user, a gift giver, may wish to purchase a gift for the second user, a gift receiver. However, the first user may not know exactly what the second user would like. Accordingly, the first user may request gift recommendations for the second user.

The media guidance application may query the first user for at least one of a purchase history for the second user, a viewing history for the second user, and a gift attribute preference for the second user. For example, the media guidance application may request the first user provide some information upon which the media guidance application may create a user profile for the second user.

The media guidance application may create a user profile associated with the second user based on the identity of the second user and at least one of the purchase history for the second user, the viewing history for the second user, and the gift attribute preference for the second user. For example, the media guidance application may use information provided by the first user (e.g., information that the user knows about the likes and/or dislikes of the second user) to create a collection of data about the second user.

The media guidance application may retrieve additional information related to the second user based on the identity of the second user. For example, the media guidance application may determine a social network account associated with the second user and parse data on the social network account to determine additional information for the user profile. In another example, the media guidance application may determine a media provider account associated with the second user and retrieve a viewing history for the media provider account. In yet another example, the media guidance application may determine an on-line retailer account associated with the second user and retrieve a purchase history for the on-line retailer account. In some embodiments, the media guidance application may verify that the additional information corresponds to the second user (e.g., by comparing the consistency of the information received from the first user and the additional information). Additionally or alternatively, the media guidance application may process privacy settings for the second user to determine what, if any, additional information may be used for the user profile.

The media guidance application may supplement the user profile with the additional information. For example, in order to expand on the amount of information available to the media guidance application for determining gift recommendations, the media guidance application may supplement the information provided by the first user with the additional information. Using this broader base of information, the media guidance application may more narrowly tailor the gift recommendations to the user.

The media guidance application may filter a list of recommended gifts based on the supplemented user profile. For example, the media guidance application may retrieve, from a recommendation database, a list of recommended gifts and attributes describing each recommended gift. The media guidance application may determine a weighting for each of the recommended gifts based on a comparison with the supplemented user profile. The media guidance application may then rank the list of recommended gifts by their weighting, and select a predetermined number of top ranking recommended gifts to be included in the filtered list.

The media guidance application may then provide the filtered list as a curated list of gift recommendations to the first user. In some embodiments, in order to ensure user privacy, the media guidance application may delete the supplemented user profile after providing the filtered list as the curated list of gift recommendations to the first user. For example, after using the information about the second user from various sources (including the first user), the media guidance application may delete the information to prevent further use of the information.

It should be noted that the systems and/or methods described above may be applied to, or used in accordance with, other systems, methods, and/or apparatuses.

### BRIEF DESCRIPTION OF THE DRAWINGS

The above and other objects and advantages of the disclosure will become apparent with consideration of the following detailed description, taken in conjunction with the accompanying drawings, in which like reference characters refer to like parts throughout, and in which:

FIG. 1 shows an illustrative example of a media guidance display that may be presented in accordance with some embodiments of the disclosure;

FIG. 2 shows another illustrative example of a media guidance display that may be presented in accordance with some embodiments of the disclosure;

FIG. 3 shows an illustrative user equipment device in accordance with some embodiments of the disclosure;

FIG. 4 is a diagram of an illustrative cross-platform interactive media system in accordance with some embodiments of the disclosure;

FIG. 5 is a flow-chart of illustrative steps involved in filtering a list of recommended gifts based on a set of weightings, in accordance with some embodiments of the disclosure;

FIG. 6 depicts pseudo-code which may be adapted to filter a list of recommended gifts based on a set of weightings, in accordance with some embodiments of the disclosure;

FIG. 7 is a flow-chart of illustrative steps involved in retrieving a list of recommended gifts from a gift database, in accordance with some embodiments of the disclosure;

FIG. 8 depicts pseudo-code which may be adapted to retrieve a list of recommended gifts from a gift database, in accordance with some embodiments of the disclosure;

FIG. 9 is a flow-chart of illustrative steps involved in providing a curated list of gift recommendations based on a user request, in accordance with some embodiments of the disclosure;

FIG. 10 is a flow-chart of illustrative steps involved in determining a weighting for a recommended gift based on a user profile, in accordance with some embodiments of the disclosure;

FIG. 11 is a flow-chart of illustrative steps involved in providing a curated list of gift recommendations based on multiple user profiles and parsing a user request using natural language processing, in accordance with some embodiments of the disclosure; and

FIG. 12 is a flow-chart of illustrative steps involved in providing a curated list of gift recommendations based on a supplemented user profile, in accordance with some embodiments of the disclosure.

### DESCRIPTION

Accordingly, methods and systems are described herein for providing a curated list of gift recommendations for users without querying the users or publicly disclosing information about the users. For example, a media guidance application described herein may identify a list of recommended gifts that share a particular attribute provided by a first user. The media guidance application may then compare each of the recommended gifts with a user profile for a second user to determine a weighting for each gift. The media guidance application may then filter the list of gifts based on the weightings, and present the filtered list of gifts to the first user as a curated list of gift recommendations. Thus the system is able to produce gift recommendations that are personalized to both the gift giver and the gift recipient, while requiring only limited access to the gift recipient's user profile.

The amount of content available to users in any given content delivery system can be substantial. Consequently, many users desire a form of media guidance through an interface that allows users to efficiently navigate content selections and easily identify content that they may desire. An application that provides such guidance is referred to herein as an interactive media guidance application or, sometimes, a media guidance application or a guidance application.

Interactive media guidance applications may take various forms depending on the content for which they provide guidance. One typical type of media guidance application is an interactive television program guide. Interactive television program guides (sometimes referred to as electronic program guides) are well-known guidance applications that, among other things, allow users to navigate among and locate many types of content or media assets. Interactive media guidance applications may generate graphical user interface screens that enable a user to navigate among, locate and select content. As referred to herein, the terms “media asset” and “content” should be understood to mean an electronically consumable user asset, such as television programming, as well as pay-per-view programs, on-demand programs (as in video-on-demand (VOD) systems), Internet content (e.g., streaming content, downloadable content, Webcasts, etc.), video clips, audio, content information, pictures, rotating images, documents, playlists, websites, articles, books, electronic books, blogs, promotional materials, chat sessions, social media, applications, games, and/or any other media or multimedia and/or combination of the same. Guidance applications also allow users to navigate among and locate content. As referred to herein, the term “multimedia” should be understood to mean content that utilizes at least two different content forms described above, for example, text, audio, images, video, or interactivity content forms. Content may be recorded, played, displayed or accessed by user equipment devices, but can also be part of a live performance. A media guidance application may also be used to provide recommendations to users. For example, a media guidance application may recommend content such as movies, videos, internet content, products, services, and the like, that users may enjoy. These recommendations may be based on a number of factors, such as a user profile, a viewing history, a purchase history, user settings, device specific data, and the like. In some embodiments the media guidance application may also provide recommendations for content available via websites, apps, and internet based services.

The media guidance application and/or any instructions for performing any of the embodiments discussed herein may be encoded on computer readable media. Computer readable media includes any media capable of storing data. The computer readable media may be transitory, including, but not limited to, propagating electrical or electromagnetic signals, or may be non-transitory including, but not limited to, volatile and non-volatile computer memory or storage devices such as a hard disk, floppy disk, USB drive, DVD, CD, media cards, register memory, processor caches, Random Access Memory (“RAM”), etc.

In some embodiments, a media guidance application may receive a request from a first user to provide gift recommendations for a second user, wherein the request comprises a desired gift attribute and an identity of the second user. For example, a first user may want to request a gift recommendation for a friend that has expressed a newfound interest in fly-fishing. In this scenario, the media guidance application may receive a request for gifts with the attribute “related to fly-fishing,” along with the identity of the friend. In some embodiments the first user may make this request by selecting a series of menu options presented by a media guidance application through a display. For example, he or she can select the friend from a list of contacts, and he or she can select the attribute from a list of possible gift attributes. In some embodiments the user may enter the request as text. For example, the first user may enter in the term “fly-fishing” by selecting a series of letters using a remote control, and identify the intended recipient of the gift by selecting a link to the friend's user profile. In some embodiments the media guidance application may also auto-correct or autofill fields. For example, if the first user types in “fly fishing” the media guidance application may perform a spell check and do a search for similar attributes to determine that “related to fly-fishing” is the requested attribute. Similarly, if a user begins to type in the name of the gift recipient, “Jeff Ca” the media guidance application may search through a list of friends or contacts associated with the first user to identify the recipient as “Jeff Calhoun” and autocomplete the text by filling in the remainder of the name automatically. In some embodiments the media guidance application may also receive a user signature or key that identifies the second user, and provides access to a user profile associated with the second user. For example, friends may exchange signatures or keys beforehand, and the media guidance application may maintain a stored list of user signatures and keys.

In some embodiments the media guidance application may receive the identity of the second user in the form a name, a pseudonym, such as a username the second user uses online, or a uniform resource locator (URL) associated with the second user, such as a link to the second user's social media account. For example, the first user may identify the second user by selecting his or her name from a list of contacts. Similarly, the first user may identify the second user by providing a link to the second user's profile on a social media site. In some embodiments, the second user may provide a link or passcode that acts as an identity and provides limited access to the user profile of the second user. For example, the second user may have a limited user profile that is only accessible with a passcode, or by using a specific URL. This passcode may be shared with friends, or available through a repository.

In some embodiments the identity of the second user may also be received in the form of an image or location. For example, even if the first user forgets the recipient's name, the media guidance application may receive a request to recommend a gift for a person depicted in of a photo, or request to recommend a gift for a neighbor that lives next door to the first user. If the media guidance application receives the identity of the second user in the form of an image, the media guidance application may perform facial recognition to determine the person in the photo. This may also be combined with a social graph listing friends and relations of the first user to assist in identifying the second user. The media guidance application may also transmit the photo to a website or remote server to perform the facial recognition. Once a second user has been identified, the media guidance application may retrieve other information about the second user, such as a name or a URL associated with the second user.

With the advent of the Internet, mobile computing, and high-speed wireless networks, users are accessing media on user equipment devices on which they traditionally did not. As referred to herein, the phrase “user equipment device,” “user equipment,” “user device,” “electronic device,” “electronic equipment,” “media equipment device,” or “media device” should be understood to mean any device for accessing the content described above, such as a television, a Smart TV, a set-top box, an integrated receiver decoder (IRD) for handling satellite television, a digital storage device, a digital media receiver (DMR), a digital media adapter (DMA), a streaming media device, a DVD player, a DVD recorder, a connected DVD, a local media server, a BLU-RAY player, a BLU-RAY recorder, a personal computer (PC), a laptop computer, a tablet computer, a WebTV box, a personal computer television (PC/TV), a PC media server, a PC media center, a hand-held computer, a stationary telephone, a personal digital assistant (PDA), a mobile telephone, a portable video player, a portable music player, a portable gaming machine, a smart phone, or any other television equipment, computing equipment, or wireless device, and/or combination of the same. In some embodiments, the user equipment device may have a front facing screen and a rear facing screen, multiple front screens, or multiple angled screens. In some embodiments, the user equipment device may have a front facing camera and/or a rear facing camera. On these user equipment devices, users may be able to navigate among and locate the same content available through a television. Consequently, media guidance may be available on these devices, as well. The guidance provided may be for content available only through a television, for content available only through one or more of other types of user equipment devices, or for content available both through a television and one or more of the other types of user equipment devices. The media guidance applications may be provided as on-line applications (i.e., provided on a web-site), or as stand-alone applications or clients on user equipment devices. Various devices and platforms that may implement media guidance applications are described in more detail below.

In some embodiments the media guidance application may use a combination of GPS, user profile information, and public records to identify the second user. For example, if the media guidance application receives a request to recommend a gift for a neighbor that lives at a particular address, the media guidance application may search through public records or online social media services to determine the person who lives at the address. In some embodiments several types of identification may be combined together. For example, the media guidance application may receive a request to provide a gift recommendation for “Jeff.” If the first user has two contacts with the first name “Jeff,” one of whom lives in California, and the other of whom lives in New York, the media guidance application may determine the current location of the user through either GPS or a device ID to determine which “Jeff” is the intended recipient. For example, if the first user is making a request from a cellular phone, and the phone's GPS indicates that the first user is making the request from New York, the media guidance application may determine that the “Jeff” who lives in New York is the intended recipient of the gift.

In some embodiments the media guidance application may also determine the second user from a list of scheduled events or upcoming occasions, such as upcoming birthdays, parties, anniversaries, and the like. The media guidance application may check the first user's calendar, or a list of events the first user has been invited to on a social media service, and identify possible gift recipients based on that information. For instance, if the “Jeff” who lives in California is hosting a birthday party, the media guidance application may determine that the “Jeff” who lives in California is the intended recipient. In some embodiments the media guidance application may also present a list of possible gift recipients in an order based on the information contained in the request. For example, if the intended recipient is ambiguous, the media guidance application may determine the most likely recipient and generate a display containing different potential recipients in an order based on the likelihood. If there are multiple events occurring in the near future, the media guidance application may also determine how important each event is, and give more influence to important events. For example, if two of the user's friends, “Kathy Lee” and “Kathy Chen,” are having birthday parties in the next week, but the user has only accepted an invitation to the party for “Kathy Lee,” the media guidance application may determine that the birthday party for “Kathy Lee” is more important to the user, and the media guidance application will be more likely to suggest “Kathy Lee” as the gift recipient.

In some embodiments the media guidance application may receive a list of additional gift attributes. For example, the media guidance application may receive the attributes “historical” and “book” to go along with “related to fly-fishing.” In some embodiments the media guidance application may suggest additional attributes to compliment the first attribute provided by the first user. For example, after receiving an initial request for a gift with the “related to fly-fishing” attribute, the media guidance application may suggest other related attributes such as “related to outdoor activities” and “wilderness survival” to be included in the list of additional gift attributes. In some embodiments the media guidance application may determine related attributes either by searching a database that contains a list of attributes and other related attributes, or by searching through a historical record of searches performed by users to identify attributes that are commonly searched for together. For example, the media guidance application may determine that many users search for content with both the “action” and “thriller” attributes, and if the first user provides a request that includes the “action” attribute, the media guidance application may suggest to include the “thriller” attribute as well.

In some embodiments the media guidance application may also receive a list of importance levels, wherein each element in the list of importance levels indicates a level of importance for either the gift attribute or one of the additional gift attributes. For example the media guidance application may receive a list indicating “related to fly-fishing” is very important, “book” is somewhat important, and “historical” is still desirable, but not very important. In some embodiments the importance level may be indicated qualitatively, and in other embodiments the importance level may be indicated quantitatively only relative to other importance levels. For example, the media guidance application may provide the first user with a list of possible gift attributes, along with a set of qualitative importance levels the user may assign to each attribute. For example, for each attribute the media guidance application may provide the user with an option to assign it the importance level of “very important” “somewhat important” or “not very important.” In some embodiments the media guidance application may instead allow the user to assign an importance level quantitatively by entering a number between 1 and 100. In some embodiments the media guidance application may also allow users to designate attributes to be avoided or excluded in the gift recommendations. Attributes to be avoided or excluded may have their own qualitative importance levels, or they may be denoted by negative importance levels. For example, if the first user wants a gift recommendation that is related to Japanese cuisine, but something other than a cook book, the media guidance application may receive a list of attributes and importance levels such as <“Japanese Cuisine”—importance=80; “Sushi”—importance=20; “Book”—importance=−100>. This may result in the media guidance application recommending gift ideas like the movie “Jiro Dreams of Sushi,” novelty chopsticks, podcasts about Asian food, and the like, while explicitly avoiding any type of book.

In some embodiments, the media guidance application may generate the gift attribute by applying a natural language processing algorithm to a received string of characters or spoken audio. For example, the media guidance application may receive a request to “recommend something related to fishing for Jim's fourth of July BBQ.” In some embodiments this may be received directly by the media guidance application as a string of characters entered by the first user, for example, by using a keyboard. In some embodiments the media guidance application may receive a verbal request from a user, and use speech recognition to determine the string of characters. The media guidance application may apply a natural language processing algorithm to parse out different parts of speech, identify verbs and subjects, and distinguish meaningful adjectives versus articles and other unimportant phrasing. For example, the media guidance application may determine that the verb “recommend” denotes a request is beginning, “something related to” identifies a primary attribute, “fishing” is the primary attribute, “Jim” is the subject that the recommendation is for, and “Fourth of July” and “BBQ” nouns describing secondary factors to consider. By applying natural language processing, the media guidance application may identify this as a request for a recommendation, identify “Jim” as the intended recipient, and determine “related to fishing” as the gift attribute.

In some embodiments the media guidance application may also determine a list of additional gift attributes or importance levels based on applying a natural language processing algorithm. For example, the media guidance application may identify “related to fourth of July” and “related to BBQ” as additional attributes that are somewhat important, and assign a high level of importance to the attribute “related to fishing.” In some embodiments, the media guidance application also may determine attributes that are not directly mentioned in the request, but that are related to terms included in the request. For example, the media guidance application may determine that the attributes “America” and “patriotic” are closely associated with the phrase “fourth of July,” and include them as attributes in the list.

The media guidance application may then generate a database query from the gift attribute. For example, the media guidance application may generate a database query for a particular gift attribute by formatting the query using the appropriate syntax and application programming interface (API) for the recommendation engine database that will be used. A simple database may be implemented in a language similar to SQL, and a request for gift recommendations related to “fishing” may be formatted as:

| “ | |
|---|---|
| SELECT | GiftID, |
| | GiftName, |
| | GiftType, |
| | PrimaryAttribute, |
| | SecondaryAttribute, |
| | TertiaryAttribute |

FROM Gifts
WHERE PrimaryAttribute=’ fishing’ ;
“

In some embodiments the media guidance application may generate the query based on multiple gift attributes, or importance levels associated with each gift attribute. For example, the media guidance application may utilize more sophisticated databases that may be able to handle more complex queries based on multiple attributes and importance levels.

The media guidance application may then transmit the generated query to a recommendation database, the database comprising a list of possible gifts and attributes describing each possible gift. Recommendation databases may be maintained by external websites, content providers, media guidance data providers, social media services, and the like. In some embodiments the media guidance application may establish a connection to the recommendation database over a network connection, and then transmit the query to the recommendation database. For example, the media guidance application may connect to a recommendation database hosted by a content provider as an SQL server, and then transmit the database query to the server. The recommendation database itself may be implemented several different ways. For example, a sophisticated database may contain a graph directly linking together different products and attributes describing each product, similar to a neural network model. As another example, a more basic recommendation database may comprise a relational database linking together a gift database and an attribute database. Depending on the type of database being used, the media guidance application may alter the exact format of the query to match the type of database.

The media guidance application may then retrieve, from the recommendation database, a list of recommended gifts and attributes describing each recommended gift, wherein each of the recommended gifts is described by the gift attribute. For example, after querying the recommendation database for gifts matching the attribute “related to fly-fishing,” the media guidance application may retrieve a list of recommended gifts including fishing rods, lures, or literature about fly-fishing along with a list of attributes describing each of the gifts. For example, if one of the recommended gifts is the book “History of Fly-Fishing in Fifty Flies,” the list of attributes describing the gift may include “book,” “non-fiction,” “historical,” “author: Ian Whitelaw,” “related to fly-fishing,” “related to outdoor recreation,” “vivid pictures,” and “appropriate for all ages.” In some embodiments, the media guidance application may receive recommended gifts as a data structure containing basic information about the gift, as well as attributes associated with the gift. For example, the media guidance application may receive the list of recommended gifts as an array of pointers to data structures containing recommended gifts, or a linked list where each node contains a recommended gift. A typical data structure for each of the recommended gifts may look like the following:

“
<GiftID: G2loc42>
<GiftName: “History of Fly-Fishing in Fifty

Flies”>

<GiftType: “Book”,>
<InitialWeight: “50”>
//Attributes and Relevance Levels
<Attribute “book,”: 100>
<Attribute “historical,”: 65>
<Attribute “author: Ian Whitelaw,”: 100>
<Attribute “vivid pictures,”: 75>
<Attribute “appropriate for all ages.”: 25>
“

Where the GiftID describes a unique identifier for the gift that may be used on multiple different databases and services, the GiftName is a plaintext name for the gift, the GiftType describes an overarching category the gift belongs to, the InitialWeight describes how well the gift matches the attribute used to form the database query, and each of the attributes is assigned a relevance level describing how well the attribute describes the gift. In general, there is no limit to the number of attributes that may be associated with each of the recommended gifts. For example, in the above data structure, the attribute “historical” is associated with the gift at a relevance level of 65, while “author: Ian Whitelaw,” is associated with a relevance level of 100. This may indicate that the recommendation database is 100% certain that the recommended gift is associated with the author Ian Whitelaw, but only 65% certain that the recommended gift is historical. In some embodiments the other information such as the GiftID, GiftName, GiftType, or InitialWeight may be used by the media guidance application in conjunction with the attributes and a user profile to generate a set of weightings for each of the recommended gifts. In some embodiments the relevance levels or the other information may be set by content providers or other services providing the recommendation database. In some embodiments the media guidance application may periodically transmit information back to the recommendation database to update relevance levels and other information in response to user input. For example, a user may manually reject a recommended gift by indicating it is unrelated to the initial gift attribute used to form the query. The media guidance application may then transmit that information back to the recommendation database and lower the relevance level for that attribute in the stored data structure for the recommended gift.

The media guidance application may then identify a user profile associated with the second user based on the identity of the second user, wherein the user profile comprises at least one of a purchase history, a viewing history, and gift attribute preferences. For example, if the media guidance application received the name of the second user in the original request, the media guidance application may use that information to perform a search and identify the second user's profile on a social media site, shopping site, or content provider site. In some embodiments, the media guidance application may only have limited access to the second user's profile. For example, the media guidance application may have received the identity of the second user in the form of a signature, specific URL, or passcode that allows access to a limited user profile. In some embodiments the media guidance application may have tiered levels of access to the second user's profile based on his or her relationship with the first user. For example, the second user may have personal privacy settings related to either individuals or groups of people. The second user may allow full access to his or her profile for a select group of friends using a common social media service, but they may permit only limited access to their family members, or to the public at large. In some embodiments the media guidance application may transmit a token identifying the first user to a website or service hosting the user profile of the second user, and obtain access to the profile of the second user on the basis of the token. For example, the media guidance application may identify the first user to a social media service, and the social media service may allow access to the second user's profile after internally verifying that the first user has permission to access the second user's profile. In some embodiments the media guidance application may also access a database that aggregates together user profiles from multiple different websites and services, and a signature or key may provide access to all of the profiles in the database associated with a particular user or group of users. For example, members of a fraternity house may have a single signature or key that provides access to all of the profiles associated with members of the fraternity.

In some embodiments, the user profile associated with the second user may be a sub-profile created by another user on behalf of the second user. This sub-profile may populated by another user, such as the first user, with assumed preferences, demographic information, purchase history information, viewing history information, and the like. For example, Mary may make a sub-profile containing the information she knows about her coworker Loren. Mary may know Loren has a taste for historical fiction and action-packed movies and include this information in the preference settings for the sub-profile. Mary may also be able to estimate Loren's age, and other demographic information, to be included in the sub-profile. Mary may also know that Loren recently purchased a new television, and hosted a party for the launch of the latest season of “House,” and Mary may modify the purchase and viewing preferences of the sub-profile to reflect this information. The media guidance application may store the sub-profile inside of Mary's user profile, but it may be associated with both the creator, Mary, as well as the second user, Loren. The media guidance application may then use the information contained in the sub-profile to generate gift recommendations for Mary to give to Loren. In some embodiments the media guidance application may also allow multiple users to contribute to a sub-profile, or it may allow multiple users to access the sub-profiles. For example, a group of coworkers may make a sub-profile for their supervisor before picking a retirement gift, or the mother of a small child may share a sub-profile she made on behalf of her child with other parents prior to a birthday party.

The media guidance application may then determine a weighting for each of the recommended gifts. For example, for each of the recommended gifts, the media guidance application may evaluate the gift using the information contained in the identified user profile, and determine a weighting based on the information available from the user profile. In some embodiments the media guidance application may determine a weighting while having only limited access to the user profile. For example, the media guidance application may submit the list of recommended gifts to the service hosting the user profile, and receive weightings directly.

In some embodiments the media guidance application may also receive an initial weighting for each of the recommended gifts from the recommendation database. For example, the initial weighting may describe how well each of the recommended gifts matched the gift attribute used to generate the database query. In some embodiments the initial weighting is generated independently from any user profile information, and the weighting may be changed or manipulated based on the user profile. For example, if the media guidance application was requested to provide gift recommendations with the “scary movie” attribute, the initial weighting for a recommended gift may represent the relevance level between the recommended gift and the “scary movie” attribute. Similarly, if the media guidance application was requested to provide gift recommendations based on a list of attributes and importance levels, the initial weighting for a recommended gift may represent the overall relevance level of each of the attributes, with the attributes with higher importance levels having a larger impact on the initial weighting.

In some embodiments, the media guidance application may determine the weighting by comparing the recommended gift with the purchase history of the second user. For example, for each of the recommended gifts, the media guidance application may see if the recommended gift exists in the purchase history. If the gift already exists, the media guidance application may reduce the weighting or set the weighting to zero. In some embodiments the media guidance application may provide a list of recommended gifts to a service hosting the user profile, and receive back information about only those gifts. For example, the media guidance application may generate of list of identifiers representing each gift, and transmit the list to the service hosting the user profile. For each gift the media guidance application may receive a binary variable indicating whether each of the recommended gifts already exists in the purchase history. An example of how this might be organized is shown below:

| Gift ID | Returned Value |
|---|---|
| <GiftID: G2loc42> | <0 - Not in Purchase History> |
| <GiftID: 5Axo14x> | <0 - Not in Purchase History> |
| <GiftID: B215Lnw> | <1 - Exists in Purchase History> |
| <GiftID: P2O9va5> | <0 - Not in Purchase History> |

In this case the media guidance application may set the weighting to 0 for the recommended gift with <GiftID: B215Lnw> and leave the other weightings unchanged. By receiving information on a gift-by-gift basis the media guidance application does not require full access to the user profile, and a full purchase history does not need to be disclosed. In some embodiments the media guidance application may transmit the name of the gift as the identifier. For example, rather than transmitting information from the GiftID portion of the recommended gift data structure, the media guidance application may transmit information from the GiftName portion instead.

In some embodiments, the media guidance application may compare the attributes describing the recommended gift with the gift attribute preferences of the second user. For example, the second user may have a certain set of attributes that he or she likes or dislikes, and the second user's profile may indicate that “romantic” gifts are somewhat desirable, “funny” are very desirable, and “violent” gifts are not acceptable at all. The media guidance application may then compare each of the attributes associated with a recommended gift with the attribute preferences and modify the weighting in response. For example, if the recommended gifts are a set of movies, romantic-comedy movies associated with the “funny” and “romantic” attributes may have their weighting greatly increased, and action movies associated with the “violent” attribute may have their weighting reduced to 0.

In some embodiments the media guidance application may transmit a list of attributes describing a recommended gift to a service hosting the user profile, and receive back a numerical value indicating an overall desirability for the recommended gift. For example, if a recommended gift is associated with the attributes <comedy> <romantic> <featuring Hugh Grant> and <PG-13>, the media guidance application may transmit a list of the attributes to the service and allow the service to determine a level of desirability based on the stored attribute preferences. The media guidance application may receive back a level of desirability, which can be used to increase or decrease the weighting for the recommended gift. By transmitting only sets of attributes and receiving only a single number, the media guidance application may be able to generate a set of weighting with only limited access to the second user profile, and the second user does not need to disclose any of the actual gift attribute preferences used to generate the preference levels. In some embodiments the media guidance application may also transmit a set of relevance levels along with the attributes, and the desirability may be influenced by the relevance level. For example, if the gift attribute preferences indicate that “funny” gifts are highly desirable, and two recommended gifts have the “funny” attribute, the recommended gift with the higher relevance level for the “funny” attribute will have a higher desirability, and the media guidance application may increase the weighting for that gift by a larger amount.

In some embodiments, the media guidance application may determine a preference level for one of the attributes describing the recommended gift based on the gift attribute preferences of the second user, and modify the weighting based on the determined preference level. For example, if an attribute for one of the recommended gifts is “related to fishing,” but there are no preferences in the user profile related to that attribute, the media guidance application may determine a preference level based on existing preferences. In some embodiments the media guidance application may determine a list of related attributes and determine the preference level based on the related attributes. For example, the media guidance application may determine that the “related to fishing” attribute is associated with the “hunting,” “camping,” and “rafting” attributes. If the second user has a high preference for gifts related to “hunting,” “camping,” and “rafting,” the media guidance application may determine that “related to fishing” is also a desirable attribute, and raise the weighting for recommended gifts associated with the “related to fishing” attribute. To determine that attributes are related together, the media guidance application may access either an internal or external database listing attributes and a level of similarity to other attributes, or the media guidance application may determine two attributes are related if they are both frequently associated with the same recommended gifts.

In some embodiments, the media guidance application may compare the attributes describing the recommended gift with attributes describing an item contained in the purchase history of the second user. For example, if the purchase history contains several items related to “mysticism,” such as books and memorabilia related to magic, ghosts, and Wicca, the media guidance application may increase the weighting for recommended gifts associated with the “mysticism” attribute. In some embodiments the media guidance may generate a list of attributes associated with items in the purchase history of the second user. For example, the media guidance application may go through a list of items in the purchase history and tally the number of times that each attribute describes a gift contained in the purchase history. Afterwards, the media guidance application may compare the attributes describing a recommended gift with the list of attributes associated with items in the purchase history of the second user. In some embodiments the media guidance application may receive a list of attributes associated with items in the purchase history of the second user from a service hosting the purchase history of the second user. For example, this may allow the media guidance application to compare the attributes describing the recommended gift with attributes describing an item contained in the purchase history of the second user without receiving a full purchase history, or details about any particular items contained in the purchase history.

In some embodiments the media guidance application may identify lists of synonyms and antonyms for attributes describing a recommended gift, and a similar list of synonyms and antonyms for attributes describing the items contained in the purchase history. The media guidance application may then compare the lists together and modify the weighting based on the comparison. For example, a recommended gift may be associated with the attribute “occult.” The media guidance application may generate a list of synonyms for the “occult” attribute, such as “mystical,” “mysticism,” “spiritual,” and “magical.” If the purchase history contains several items related to the “mysticism” attribute, the media guidance application may increase the weighting for the recommended gift accordingly. In some embodiments the media guidance application may determine a list of synonyms or antonyms that also contain related attributes as part of the list. For example, the “related to Halloween” attribute may be included in the list of synonyms for the “Witchcraft” attribute because they are closely related, despite not being literal synonyms.

In some embodiments, the media guidance application may compare the attributes describing the recommended gift with attributes describing an item contained in the viewing history of the second user. For example, if the recommended gift is a box set for the film “National Treasure,” one of the associated attributes may be “related to Nicolas Cage,” the actor who stars in the film. If the viewing history of the second user contains multiple films also associated with the “related to Nicolas Cage” attribute, the weighting for the recommended gift may be increased. Similarly, if the second user has an extensive viewing history, but nothing in the history is associated with the attribute “related to Nicolas Cage,” the weighting may be reduced.

In some embodiments the media guidance application may identify an additional user profile associated with the first user, wherein the additional user profile comprises at least one of a purchase history and a viewing history. The media guidance application may then determine a second weighting for each of the recommended gifts based on the information in the additional user profile, and modify determined weighting based on the second weighting. For example, if the first user is requesting that the media guidance application provide a gift recommendation for the user's wife, the media guidance application may first determine a set of weightings for each recommended gift based on the wife's profile. The media guidance application may then determine a set of weightings for each of the recommended gifts based on the first user's profile, and combine the weightings together, for example, by averaging the two weightings. In an alternate example, the media guidance application may determine a weighting for a recommended gift by using the information contained in a first profile. The determined weighting may then be used as an initial weighting when the media guidance application determines an overall weighting by comparing the recommended gift to a second profile. By incorporating information from multiple user profiles, the media guidance application may identify a recommended gift that multiple users may both enjoy.

In some embodiments the user profile associated with the first user may be a sub-profile created by the first user on behalf of the second user. For example, a father may create a sub-profile containing information about his teenage daughter. The father may populate the sub-profile with information about his daughter, such as her age, name, and other demographic information. He may also include a limited purchase or viewing history, or a set of profile preferences, such as gift preferences. For example, the father may know that his daughter recently purchased the latest Madonna music album, that she enjoys comedy movies, and that she recently watched the first season of the television show “Friends.” The media guidance application may store the sub-profile as part of a database, or as part of the father's user profile, and the sub-profile may be associated with both the father and the daughter. The media guidance application may then use this sub-profile in combination with other profiles to generate gift recommendations. For example, based on the information the father provided, the media guidance application may be able to either generate a set of gift recommendations, or determine a set of weightings for a set of gift recommendations. The media guidance application may then use the daughter's actual profile to either further refine the weightings, or to filter out certain gifts, such as items already contained in her purchase history that she may have bought independently. In some embodiment the media guidance application may receive a request that contains a user profile or sub-profile rather than a gift attribute. The media guidance application may then either determine one or more gift attributes by analyzing the information contained in the profile contained in the request, or the media guidance application may transmit the user profile directly to a recommendation database and receive gift recommendations. For example, the media guidance application may determine that a recurring theme in the viewing history contained in a sub-profile is “documentaries,” and the media guidance application may then use the gift attribute “documentaries” to generate the query. In an alternate example, the media guidance application may simply transmit the sub-profile to a recommendation engine or database, and retrieve a list of recommendations on the basis of the sub-profile.

The media guidance application may then filter the list of recommended gifts based on the determined weightings, wherein the filtering comprises removing recommended gifts with a weighting below a threshold from the list. For example, the media guidance application may set a threshold of “75” and remove any gift with a weighting below the threshold. In some embodiments, the threshold level may be set by the first user either directly or indirectly, and in other embodiments, it may be stored in the user profile of the second user. For example, the media guidance application may receive an indication from the first user that he or she is only interested in gift recommendations that are extremely likely to be enjoyed by the second user. In this case the media guidance application may set a very high threshold of “90” based on the user input. Similarly, a picky gift recipient may not be interested in receiving gifts he or she would not enjoy, and the media guidance application may retrieve a very high a threshold level from the user profile of the recipient.

The media guidance application may then provide the filtered list as a curated list of gift recommendations to the first user. For example, the media guidance application may generate a display containing the list of gift recommendations. In some embodiments, the media guidance application may also store the list of gift recommendations as part of a user profile. For example, John may be searching for a gift to celebrate an upcoming vacation to Hawaii later in the year. The media guidance application may receive a request from John to provide a curated list of gift recommendations for Jill related to the attribute “Hawaiian.” The media guidance application may store the recommendations as part of John's user profile, and John may access the recommendations at a later time, closer to the date of his trip. In some embodiments, the media guidance application may make the stored recommendations available to other users. For example, a mother may be planning dinosaur-themed birthday party for her child. The media guidance application may generated a curated list of gift recommendations, and store the recommendations. The media guidance application may then provide access to the stored recommendations to any of the birthday party attendees. In some embodiments the media guidance application may offer the first user with an opportunity to identify other users who may access the stored recommendations, or the media guidance application may provide a passcode or URL which may be used to access the stored recommendations. For example, as part of the birthday invitations, the mother may circulate a URL that may be used to access the list of recommended gifts.

In some embodiments the media guidance application may also rank the list of recommended gifts by their weighting, and select a predetermined number of the top ranking recommended gifts to be included in the filtered list. For example, the media guidance application may select the 6 recommended gifts with the highest weightings to be included in the filtered list. In some embodiments the predetermined number may be set by the first user as part of the request. For example, the media guidance application may receive an indication that the first user requires exactly 5 gift recommendations. In some embodiments the predetermined number may be set based on the user device the request is being received from. For example, if the media guidance application receives the request from a handheld device with a small screen, the media guidance application may select only 6 gifts to be included in the filtered list, and present them as a series of icons in a mosaic style display. In contrast, if the media guidance application receives the request from a device connected to a large television or monitor, the media guidance application may select a larger number of gifts to be included.

In some embodiments the media guidance application may present part of the filtered list to the user in an order based on their ranking. For example, the media guidance application may display the highest ranking gifts towards to top of the screen, or prominently feature the highest ranking gifts within a mosaic display. In some embodiments, the media guidance application may store the filtered list, and, at a later time, select a subset of the filtered list to be presented to the user. For example, the media guidance application may store a filtered list containing 20 curated gift recommendations. At a later point, the media guidance application may receive a request to generate a display containing the gift recommendations. The media guidance application may then select a subset of the stored list to present based on the type of user device the request was received from. For example, a small screen may only be able to display a handful of recommendations simultaneously, while a larger screen may be able to display dozens of recommendations. In some embodiments the media guidance application may select only the top-ranked gifts from the filtered list to be displayed. In other embodiments, the media guidance application may display a number of top-ranked gifts, as well as a number of lower-ranked gifts. For example, at the bottom of the screen the media guidance application may generate a display containing “wildcard” gifts, that have a lower ranking, but still match the original gift attribute included in the request.

It should be noted that the systems and/or methods described above may be applied to, or used in accordance with, other systems, methods, and/or apparatuses.

One of the functions of the media guidance application is to provide media guidance data to users. As referred to herein, the phrase “media guidance data” or “guidance data” should be understood to mean any data related to content or data used in operating the guidance application. For example, the guidance data may include program information, guidance application settings, user preferences, user profile information, media listings, media-related information (e.g., broadcast times, broadcast channels, titles, descriptions, ratings information (e.g., parental control ratings, critic's ratings, etc.), genre or category information, actor information, logo data for broadcasters' or providers' logos, etc.), media format (e.g., standard definition, high definition, 3D, etc.), advertisement information (e.g., text, images, media clips, etc.), on-demand information, blogs, websites, and any other type of guidance data that is helpful for a user to navigate among and locate desired content selections. For example, in some embodiments of the invention, the media guidance application may identify a profile associated with the second user by using media guidance data, or retrieve the profile from media guidance data. In some embodiments, the media guidance application may store the curated list of gift recommendations within the media guidance data. For example, after receiving a request from a first user to provide a curated list of gift recommendations for a second user, the media guidance application may provide a list of recommendations to the first user, and additionally store the list within the user profile information for either the first or second user.

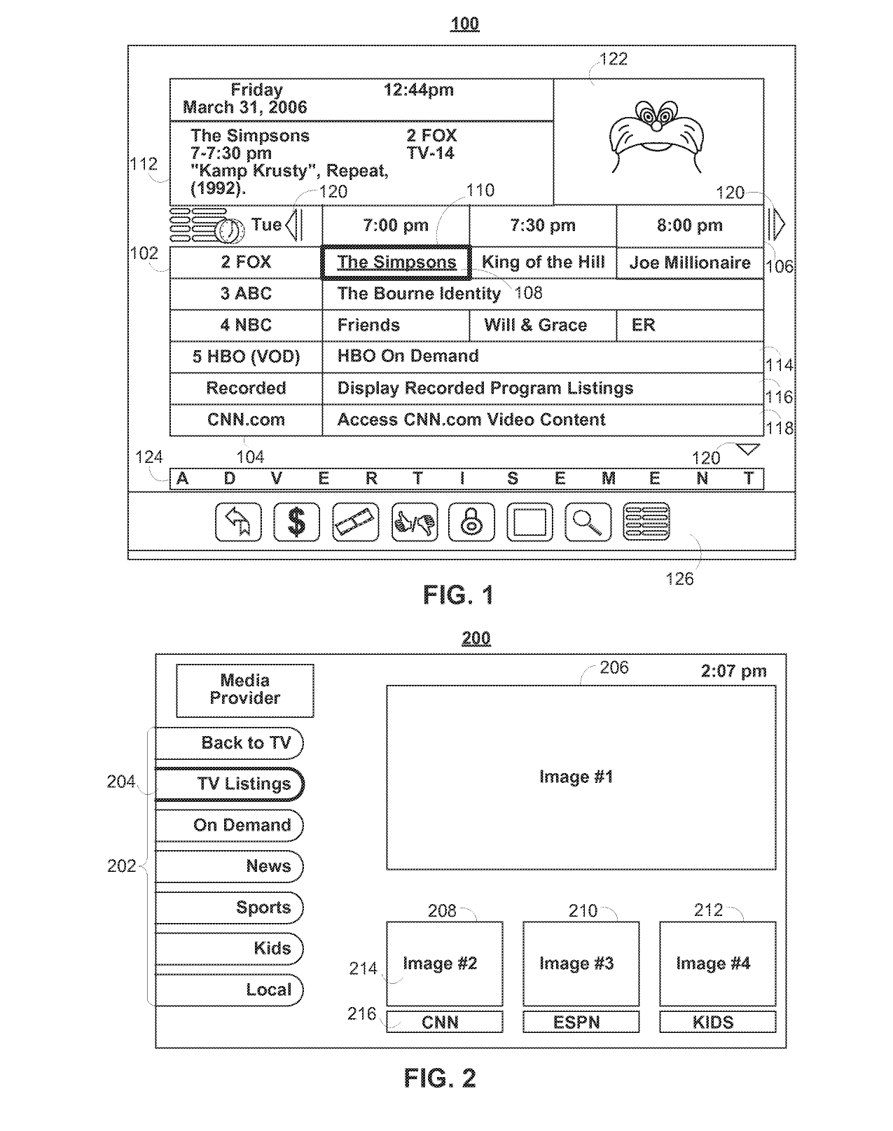

FIGS. 1-2 show illustrative display screens that may be used to provide media guidance data. The display screens shown in FIGS. 1-2 may be implemented on any suitable user equipment device or platform. While the displays of FIGS. 1-2 are illustrated as full screen displays, they may also be fully or partially overlaid over content being displayed. A user may indicate a desire to access content information by selecting a selectable option provided in a display screen (e.g., a menu option, a listings option, an icon, a hyperlink, etc.) or pressing a dedicated button (e.g., a GUIDE button) on a remote control or other user input interface or device. In response to the user's indication, the media guidance application may provide a display screen with media guidance data organized in one of several ways, such as by time and channel in a grid, by time, by channel, by source, by content type, by category (e.g., movies, sports, news, children, or other categories of programming), or other predefined, user-defined, or other organization criteria.

FIG. 1 shows illustrative grid of a program listings display 100 arranged by time and channel that also enables access to different types of content in a single display. Display 100 may include grid 102 with: (1) a column of channel/content type identifiers 104, where each channel/content type identifier (which is a cell in the column) identifies a different channel or content type available; and (2) a row of time identifiers 106, where each time identifier (which is a cell in the row) identifies a time block of programming. Grid 102 also includes cells of program listings, such as program listing 108, where each listing provides the title of the program provided on the listing's associated channel and time. With a user input device, a user can select program listings by moving highlight region 110. Information relating to the program listing selected by highlight region 110 may be provided in program information region 112. Region 112 may include, for example, the program title, the program description, the time the program is provided (if applicable), the channel the program is on (if applicable), the program's rating, and other desired information.

In addition to providing access to linear programming (e.g., content that is scheduled to be transmitted to a plurality of user equipment devices at a predetermined time and is provided according to a schedule), the media guidance application also provides access to non-linear programming (e.g., content accessible to a user equipment device at any time and is not provided according to a schedule). Non-linear programming may include content from different content sources including on-demand content (e.g., VOD), Internet content (e.g., streaming media, downloadable media, etc.), locally stored content (e.g., content stored on any user equipment device described above or other storage device), or other time-independent content. On-demand content may include movies or any other content provided by a particular content provider (e.g., HBO On Demand providing “The Sopranos” and “Curb Your Enthusiasm”). HBO ON DEMAND is a service mark owned by Time Warner Company L.P. et al. and THE SOPRANOS and CURB YOUR ENTHUSIASM are trademarks owned by the Home Box Office, Inc. Internet content may include web events, such as a chat session or Webcast, or content available on-demand as streaming content or downloadable content through an Internet web site or other Internet access (e.g. FTP).

Grid 102 may provide media guidance data for non-linear programming including on-demand listing 114, recorded content listing 116, and Internet content listing 118. A display combining media guidance data for content from different types of content sources is sometimes referred to as a “mixed-media” display. Various permutations of the types of media guidance data that may be displayed that are different than display 100 may be based on user selection or guidance application definition (e.g., a display of only recorded and broadcast listings, only on-demand and broadcast listings, etc.). As illustrated, listings 114, 116, and 118 are shown as spanning the entire time block displayed in grid 102 to indicate that selection of these listings may provide access to a display dedicated to on-demand listings, recorded listings, or Internet listings, respectively. In some embodiments, listings for these content types may be included directly in grid 102. Additional media guidance data may be displayed in response to the user selecting one of the navigational icons 120. (Pressing an arrow key on a user input device may affect the display in a similar manner as selecting navigational icons 120.)

Display 100 may also include video region 122, advertisement 124, and options region 126. Video region 122 may allow the user to view and/or preview programs that are currently available, will be available, or were available to the user. The content of video region 122 may correspond to, or be independent from, one of the listings displayed in grid 102. Grid displays including a video region are sometimes referred to as picture-in-guide (PIG) displays. PIG displays and their functionalities are described in greater detail in Satterfield et al. U.S. Pat. No. 6,564,378, issued May 13, 2003 and Yuen et al. U.S. Pat. No. 6,239,794, issued May 29, 2001, which are hereby incorporated by reference herein in their entireties. PIG displays may be included in other media guidance application display screens of the embodiments described herein.

Advertisement 124 may provide an advertisement for content that, depending on a viewer's access rights (e.g., for subscription programming), is currently available for viewing, will be available for viewing in the future, or may never become available for viewing, and may correspond to or be unrelated to one or more of the content listings in grid 102. Advertisement 124 may also be for products or services related or unrelated to the content displayed in grid 102. Advertisement 124 may be selectable and provide further information about content, provide information about a product or a service, enable purchasing of content, a product, or a service, provide content relating to the advertisement, etc. Advertisement 124 may be targeted based on a user's profile/preferences, monitored user activity, the type of display provided, or on other suitable targeted advertisement bases.

While advertisement 124 is shown as rectangular or banner shaped, advertisements may be provided in any suitable size, shape, and location in a guidance application display. For example, advertisement 124 may be provided as a rectangular shape that is horizontally adjacent to grid 102. This is sometimes referred to as a panel advertisement. In addition, advertisements may be overlaid over content or a guidance application display or embedded within a display. Advertisements may also include text, images, rotating images, video clips, or other types of content described above. Advertisements may be stored in a user equipment device having a guidance application, in a database connected to the user equipment, in a remote location (including streaming media servers), or on other storage means, or a combination of these locations. Providing advertisements in a media guidance application is discussed in greater detail in, for example, Knudson et al., U.S. Patent Application Publication No. 2003/0110499, filed Jan. 17, 2003; Ward, III et al. U.S. Pat. No. 6,756,997, issued Jun. 29, 2004; and Schein et al. U.S. Pat. No. 6,388,714, issued May 14, 2002, which are hereby incorporated by reference herein in their entireties. It will be appreciated that advertisements may be included in other media guidance application display screens of the embodiments described herein.

Options region 126 may allow the user to access different types of content, media guidance application displays, and/or media guidance application features. Options region 126 may be part of display 100 (and other display screens described herein), or may be invoked by a user by selecting an on-screen option or pressing a dedicated or assignable button on a user input device. The selectable options within options region 126 may concern features related to program listings in grid 102 or may include options available from a main menu display. Features related to program listings may include searching for other air times or ways of receiving a program, recording a program, enabling series recording of a program, setting program and/or channel as a favorite, purchasing a program, or other features. Options available from a main menu display may include search options, VOD options, parental control options, Internet options, cloud-based options, device synchronization options, second screen device options, options to access various types of media guidance data displays, options to subscribe to a premium service, options to edit a user's profile, options to access a browse overlay, or other options. For example, one of the other selectable options provided by the media guidance application within region 126 may provide an interface for requesting gift recommendations.

The media guidance application may be personalized based on a user's preferences. A personalized media guidance application allows a user to customize displays and features to create a personalized “experience” with the media guidance application. This personalized experience may be created by allowing a user to input these customizations and/or by the media guidance application monitoring user activity to determine various user preferences. Users may access their personalized guidance application by logging in or otherwise identifying themselves to the guidance application. Customization of the media guidance application may be made in accordance with a user profile. The customizations may include varying presentation schemes (e.g., color scheme of displays, font size of text, etc.), aspects of content listings displayed (e.g., only HDTV or only 3D programming, user-specified broadcast channels based on favorite channel selections, re-ordering the display of channels, recommended content, etc.), desired recording features (e.g., recording or series recordings for particular users, recording quality, etc.), parental control settings, customized presentation of Internet content (e.g., presentation of social media content, e-mail, electronically delivered articles, etc.) and other desired customizations. Additionally, users may customize the media guidance application with different privacy settings, controlling who may access his or her user profiles, or controlling which portions of his or her user profiles are accessible to others. In some embodiments the media guidance application may also provide an option for users to set preferences related to receiving, sending, or exchanging gifts. For example, the media guidance application may be customized with a set of gift preferences, denoting particular types of gifts or gift attributes that a user may want to receive. A user interested in receiving books, movies, or temporary access to rental or VOD content may include this information in his or her gift preferences. The media guidance application may then use those preferences when determining gift recommendations.

The media guidance application may allow a user to provide user profile information or may automatically compile user profile information. The media guidance application may, for example, monitor the content the user accesses and/or other interactions the user may have with the guidance application. For instance, the media guidance application may determine a purchase history or a viewing history to be included as part of a user profile. Additionally, the media guidance application may obtain all or part of other user profiles that are related to a particular user (e.g., from other web sites on the Internet the user accesses, such as www.allrovi.com, from other media guidance applications the user accesses, from other interactive applications the user accesses, from another user equipment device of the user, etc.), and/or obtain information about the user from other sources that the media guidance application may access. As a result, a user can be provided with a unified guidance application experience across the user's different user equipment devices. This type of user experience is described in greater detail below in connection with FIG. 4. Additional personalized media guidance application features are described in greater detail in Ellis et al., U.S. Patent Application Publication No. 2005/0251827, filed Jul. 11, 2005, Boyer et al., U.S. Pat. No. 7,165,098, issued Jan. 16, 2007, and Ellis et al., U.S. Patent Application Publication No. 2002/0174430, filed Feb. 21, 2002, which are hereby incorporated by reference herein in their entireties.

Another display arrangement for providing media guidance is shown in FIG. 2. Video mosaic display 200 includes selectable options 202 for content information organized based on content type, genre, and/or other organization criteria. In display 200, television listings option 204 is selected, thus providing listings 206, 208, 210, and 212 as broadcast program listings. In display 200 the listings may provide graphical images including cover art, still images from the content, video clip previews, live video from the content, or other types of content that indicate to a user the content being described by the media guidance data in the listing. Each of the graphical listings may also be accompanied by text to provide further information about the content associated with the listing. For example, listing 208 may include more than one portion, including media portion 214 and text portion 216. Media portion 214 and/or text portion 216 may be selectable to view content in full-screen or to view information related to the content displayed in media portion 214 (e.g., to view listings for the channel that the video is displayed on).

The listings in display 200 are of different sizes (i.e., listing 206 is larger than listings 208, 210, and 212), but if desired, all the listings may be the same size. Listings may be of different sizes or graphically accentuated to indicate degrees of interest to the user or to emphasize certain content, as desired by the content provider or based on user preferences. Various systems and methods for graphically accentuating content listings are discussed in, for example, Yates, U.S. Patent Application Publication No. 2010/0153885, filed Nov. 12, 2009, which is hereby incorporated by reference herein in its entirety.

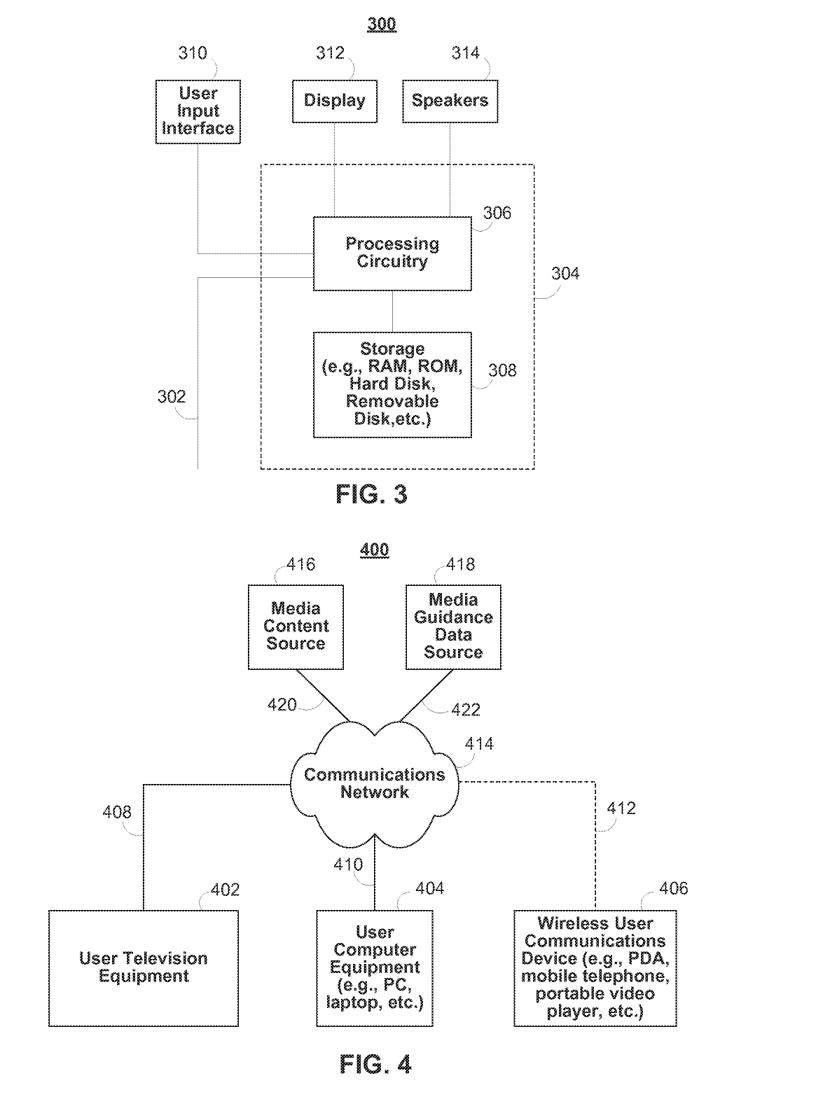

Users may access content and the media guidance application (and its display screens described above and below) from one or more of their user equipment devices. FIG. 3 shows a generalized embodiment of illustrative user equipment device 300. More specific implementations of user equipment devices are discussed below in connection with FIG. 4. User equipment device 300 may receive content and data via input/output (hereinafter “I/O”) path 302. I/O path 302 may provide content (e.g., broadcast programming, on-demand programming, Internet content, content available over a local area network (LAN) or wide area network (WAN), and/or other content) and data to control circuitry 304, which includes processing circuitry 306 and storage 308. Control circuitry 304 may be used to send and receive commands, requests, and other suitable data using I/O path 302. I/O path 302 may connect control circuitry 304 (and specifically processing circuitry 306) to one or more communications paths (described below). I/O functions may be provided by one or more of these communications paths, but are shown as a single path in FIG. 3 to avoid overcomplicating the drawing.

Control circuitry 304 may be based on any suitable processing circuitry such as processing circuitry 306. As referred to herein, processing circuitry should be understood to mean circuitry based on one or more microprocessors, microcontrollers, digital signal processors, programmable logic devices, field-programmable gate arrays (FPGAs), application-specific integrated circuits (ASICs), etc., and may include a multi-core processor (e.g., dual-core, quad-core, hexa-core, or any suitable number of cores) or supercomputer. In some embodiments, processing circuitry may be distributed across multiple separate processors or processing units, for example, multiple of the same type of processing units (e.g., two Intel Core i7 processors) or multiple different processors (e.g., an Intel Core i5 processor and an Intel Core i7 processor). In some embodiments, control circuitry 304 executes instructions for a media guidance application stored in memory (i.e., storage 308). Specifically, control circuitry 304 may be instructed by the media guidance application to perform the functions discussed above and below. For example, the media guidance application may provide instructions to control circuitry 304 to generate the media guidance displays, retrieve gift recommendations from a recommendation database, or filter gift recommendations using information contained in user profiles. In some implementations, any action performed by control circuitry 304 may be based on instructions received from the media guidance application.

In client-server based embodiments, control circuitry 304 may include communications circuitry suitable for communicating with a guidance application server or other networks or servers. The instructions for carrying out the above mentioned functionality may be stored on the guidance application server. Communications circuitry may include a cable modem, an integrated services digital network (ISDN) modem, a digital subscriber line (DSL) modem, a telephone modem, Ethernet card, or a wireless modem for communications with other equipment, or any other suitable communications circuitry. Such communications may involve the Internet or any other suitable communications networks or paths (which is described in more detail in connection with FIG. 4). In addition, communications circuitry may include circuitry that enables peer-to-peer communication of user equipment devices, or communication of user equipment devices in locations remote from each other (described in more detail below).

Memory may be an electronic storage device provided as storage 308 that is part of control circuitry 304. As referred to herein, the phrase “electronic storage device” or “storage device” should be understood to mean any device for storing electronic data, computer software, or firmware, such as random-access memory, read-only memory, hard drives, optical drives, digital video disc (DVD) recorders, compact disc (CD) recorders, BLU-RAY disc (BD) recorders, BLU-RAY 3D disc recorders, digital video recorders (DVR, sometimes called a personal video recorder, or PVR), solid state devices, quantum storage devices, gaming consoles, gaming media, or any other suitable fixed or removable storage devices, and/or any combination of the same. Storage 308 may be used to store various types of content described herein as well as media guidance data described above. Nonvolatile memory may also be used (e.g., to launch a boot-up routine and other instructions). Cloud-based storage, described in relation to FIG. 4, may be used to supplement storage 308 or instead of storage 308.

Control circuitry 304 may include video generating circuitry and tuning circuitry, such as one or more analog tuners, one or more MPEG-2 decoders or other digital decoding circuitry, high-definition tuners, or any other suitable tuning or video circuits or combinations of such circuits. Encoding circuitry (e.g., for converting over-the-air, analog, or digital signals to MPEG signals for storage) may also be provided. Control circuitry 304 may also include scaler circuitry for upconverting and downconverting content into the preferred output format of the user equipment 300. Circuitry 304 may also include digital-to-analog converter circuitry and analog-to-digital converter circuitry for converting between digital and analog signals. The tuning and encoding circuitry may be used by the user equipment device to receive and to display, to play, or to record content. The tuning and encoding circuitry may also be used to receive guidance data. The circuitry described herein, including for example, the tuning, video generating, encoding, decoding, encrypting, decrypting, scaler, and analog/digital circuitry, may be implemented using software running on one or more general purpose or specialized processors. Multiple tuners may be provided to handle simultaneous tuning functions (e.g., watch and record functions, picture-in-picture (PIP) functions, multiple-tuner recording, etc.). If storage 308 is provided as a separate device from user equipment 300, the tuning and encoding circuitry (including multiple tuners) may be associated with storage 308.

A user may send instructions to control circuitry 304 using user input interface 310. User input interface 310 may be any suitable user interface, such as a remote control, mouse, trackball, keypad, keyboard, touch screen, touchpad, stylus input, joystick, voice recognition interface, or other user input interfaces. Display 312 may be provided as a stand-alone device or integrated with other elements of user equipment device 300. For example, display 312 may be a touchscreen or touch-sensitive display. In such circumstances, user input interface 310 may be integrated with or combined with display 312. Display 312 may be one or more of a monitor, a television, a liquid crystal display (LCD) for a mobile device, amorphous silicon display, low temperature poly silicon display, electronic ink display, electrophoretic display, active matrix display, electro-wetting display, electrofluidic display, cathode ray tube display, light-emitting diode display, electroluminescent display, plasma display panel, high-performance addressing display, thin-film transistor display, organic light-emitting diode display, surface-conduction electron-emitter display (SED), laser television, carbon nanotubes, quantum dot display, interferometric modulator display, or any other suitable equipment for displaying visual images. In some embodiments, display 312 may be HDTV-capable. In some embodiments, display 312 may be a 3D display, and the interactive media guidance application and any suitable content may be displayed in 3D. A video card or graphics card may generate the output to the display 312. The video card may offer various functions such as accelerated rendering of 3D scenes and 2D graphics, MPEG-2/MPEG-4 decoding, TV output, or the ability to connect multiple monitors. The video card may be any processing circuitry described above in relation to control circuitry 304. The video card may be integrated with the control circuitry 304. Speakers 314 may be provided as integrated with other elements of user equipment device 300 or may be stand-alone units. The audio component of videos and other content displayed on display 312 may be played through speakers 314. In some embodiments, the audio may be distributed to a receiver (not shown), which processes and outputs the audio via speakers 314.

The guidance application may be implemented using any suitable architecture. For example, it may be a stand-alone application wholly-implemented on user equipment device 300. In such an approach, instructions of the application are stored locally (e.g., in storage 308), and data for use by the application is downloaded on a periodic basis (e.g., from an out-of-band feed, from an Internet resource, or using another suitable approach). Control circuitry 304 may retrieve instructions of the application from storage 308 and process the instructions to generate any of the displays discussed herein. Based on the processed instructions, control circuitry 304 may determine what action to perform when input is received from input interface 310. For example, movement of a cursor on a display up/down may be indicated by the processed instructions when input interface 310 indicates that an up/down button was selected.

In some embodiments, the media guidance application is a client-server based application. Data for use by a thick or thin client implemented on user equipment device 300 is retrieved on-demand by issuing requests to a server remote to the user equipment device 300. In one example of a client-server based guidance application, control circuitry 304 runs a web browser that interprets web pages provided by a remote server. For example, the remote server may store the instructions for the application in a storage device. The remote server may process the stored instructions using circuitry (e.g., control circuitry 304) and generate the displays discussed above and below. The client device may receive the displays generated by the remote server and may display the content of the displays locally on equipment device 300. This way, the processing of the instructions is performed remotely by the server while the resulting displays are provided locally on equipment device 300. Equipment device 300 may receive inputs from the user via input interface 310 and transmit those inputs to the remote server for processing and generating the corresponding displays. For example, equipment device 300 may transmit a communication to the remote server indicating that an up/down button was selected via input interface 310. The remote server may process instructions in accordance with that input and generate a display of the application corresponding to the input (e.g., a display that moves a cursor up/down). The generated display is then transmitted to equipment device 300 for presentation to the user. In some embodiments, multiple instances of media guidance applications associated with different users may communicate together. For example, a first media guidance application with access to only a user profile associated with a first user may receive a request to provide gift recommendations for a second user based on a particular attribute. The first media guidance application may retrieve a list of recommended gifts based on the attribute from a recommendation database, and transmit the list to the second media guidance application, wherein the second media guidance application has access to the user profile for the second user. The first media guidance application may then receive either a list of preference levels or weighting from the second media guidance application, and the first media guidance application may use that information to filter the list of recommended gifts.

In some embodiments, the media guidance application is downloaded and interpreted or otherwise run by an interpreter or virtual machine (run by control circuitry 304). In some embodiments, the guidance application may be encoded in the ETV Binary Interchange Format (EBIF), received by control circuitry 304 as part of a suitable feed, and interpreted by a user agent running on control circuitry 304. For example, the guidance application may be an EBIF application. In some embodiments, the guidance application may be defined by a series of JAVA-based files that are received and run by a local virtual machine or other suitable middleware executed by control circuitry 304. In some of such embodiments (e.g., those employing MPEG-2 or other digital media encoding schemes), the guidance application may be, for example, encoded and transmitted in an MPEG-2 object carousel with the MPEG audio and video packets of a program.

User equipment device 300 of FIG. 3 can be implemented in system 400 of FIG. 4 as user television equipment 402, user computer equipment 404, wireless user communications device 406, or any other type of user equipment suitable for accessing content, such as a non-portable gaming machine. For simplicity, these devices may be referred to herein collectively as user equipment or user equipment devices, and may be substantially similar to user equipment devices described above. User equipment devices, on which a media guidance application may be implemented, may function as a standalone device or may be part of a network of devices. Various network configurations of devices may be implemented and are discussed in more detail below.

A user equipment device utilizing at least some of the system features described above in connection with FIG. 3 may not be classified solely as user television equipment 402, user computer equipment 404, or a wireless user communications device 406. For example, user television equipment 402 may, like some user computer equipment 404, be Internet-enabled allowing for access to Internet content, while user computer equipment 404 may, like some television equipment 402, include a tuner allowing for access to television programming. The media guidance application may have the same layout on various different types of user equipment or may be tailored to the display capabilities of the user equipment. For example, on user computer equipment 404, the guidance application may be provided as a web site accessed by a web browser. In another example, the guidance application may be scaled down for wireless user communications devices 406.

In system 400, there is typically more than one of each type of user equipment device but only one of each is shown in FIG. 4 to avoid overcomplicating the drawing. In addition, each user may utilize more than one type of user equipment device and also more than one of each type of user equipment device.

In some embodiments, a user equipment device (e.g., user television equipment 402, user computer equipment 404, wireless user communications device 406) may be referred to as a “second screen device.” For example, a second screen device may supplement content presented on a first user equipment device. The content presented on the second screen device may be any suitable content that supplements the content presented on the first device. In some embodiments, the second screen device provides an interface for adjusting settings and display preferences of the first device. In some embodiments, the second screen device is configured for interacting with other second screen devices or for interacting with a social network. The second screen device can be located in the same room as the first device, a different room from the first device but in the same house or building, or in a different building from the first device.

The user may also set various settings to maintain consistent media guidance application settings across in-home devices and remote devices. Settings include those described herein, as well as channel and program favorites, programming preferences that the guidance application utilizes to make programming recommendations, display preferences, and other desirable guidance settings. For example, if a user sets a channel as a favorite on, for example, the web site www.allrovi.com on their personal computer at their office, the same channel would appear as a favorite on the user's in-home devices (e.g., user television equipment and user computer equipment) as well as the user's mobile devices, if desired. Therefore, changes made on one user equipment device can change the guidance experience on another user equipment device, regardless of whether they are the same or a different type of user equipment device. In addition, the changes made may be based on settings input by a user, as well as user activity monitored by the guidance application.

The user equipment devices may be coupled to communications network 414. Namely, user television equipment 402, user computer equipment 404, and wireless user communications device 406 are coupled to communications network 414 via communications paths 408, 410, and 412, respectively. Communications network 414 may be one or more networks including the Internet, a mobile phone network, mobile voice or data network (e.g., a 4G or LTE network), cable network, public switched telephone network, or other types of communications network or combinations of communications networks. Paths 408, 410, and 412 may separately or together include one or more communications paths, such as, a satellite path, a fiber-optic path, a cable path, a path that supports Internet communications (e.g., IPTV), free-space connections (e.g., for broadcast or other wireless signals), or any other suitable wired or wireless communications path or combination of such paths. Path 412 is drawn with dotted lines to indicate that in the exemplary embodiment shown in FIG. 4 it is a wireless path and paths 408 and 410 are drawn as solid lines to indicate they are wired paths (although these paths may be wireless paths, if desired). Communications with the user equipment devices may be provided by one or more of these communications paths, but are shown as a single path in FIG. 4 to avoid overcomplicating the drawing.

Although communications paths are not drawn between user equipment devices, these devices may communicate directly with each other via communication paths, such as those described above in connection with paths 408, 410, and 412, as well as other short-range point-to-point communication paths, such as USB cables, IEEE 1394 cables, wireless paths (e.g., Bluetooth, infrared, IEEE 802-11x, etc.), or other short-range communication via wired or wireless paths. BLUETOOTH is a certification mark owned by Bluetooth SIG, INC. The user equipment devices may also communicate with each other directly through an indirect path via communications network 414.

System 400 includes content source 416 and media guidance data source 418 coupled to communications network 414 via communication paths 420 and 422, respectively. Paths 420 and 422 may include any of the communication paths described above in connection with paths 408, 410, and 412. Communications with the content source 416 and media guidance data source 418 may be exchanged over one or more communications paths, but are shown as a single path in FIG. 4 to avoid overcomplicating the drawing. In addition, there may be more than one of each of content source 416 and media guidance data source 418, but only one of each is shown in FIG. 4 to avoid overcomplicating the drawing. (The different types of each of these sources are discussed below.) If desired, content source 416 and media guidance data source 418 may be integrated as one source device. Although communications between sources 416 and 418 with user equipment devices 402, 404, and 406 are shown as through communications network 414, in some embodiments, sources 416 and 418 may communicate directly with user equipment devices 402, 404, and 406 via communication paths (not shown) such as those described above in connection with paths 408, 410, and 412.

Content source 416 may include one or more types of content distribution equipment including a television distribution facility, cable system headend, satellite distribution facility, programming sources (e.g., television broadcasters, such as NBC, ABC, HBO, etc.), intermediate distribution facilities and/or servers, Internet providers, on-demand media servers, and other content providers. NBC is a trademark owned by the National Broadcasting Company, Inc., ABC is a trademark owned by the American Broadcasting Company, Inc., and HBO is a trademark owned by the Home Box Office, Inc. Content source 416 may be the originator of content (e.g., a television broadcaster, a Webcast provider, etc.) or may not be the originator of content (e.g., an on-demand content provider, an Internet provider of content of broadcast programs for downloading, etc.). Content source 416 may include cable sources, satellite providers, on-demand providers, Internet providers, over-the-top content providers, or other providers of content. Content source 416 may also include a remote media server used to store different types of content (including video content selected by a user), in a location remote from any of the user equipment devices. Systems and methods for remote storage of content, and providing remotely stored content to user equipment are discussed in greater detail in connection with Ellis et al., U.S. Pat. No. 7,761,892, issued Jul. 20, 2010, which is hereby incorporated by reference herein in its entirety.

Media guidance data source 418 may provide media guidance data, such as the media guidance data described above. Media guidance data may be provided to the user equipment devices using any suitable approach. In some embodiments, the guidance application may be a stand-alone interactive television program guide that receives program guide data via a data feed (e.g., a continuous feed or trickle feed). Program schedule data and other guidance data may be provided to the user equipment on a television channel sideband, using an in-band digital signal, using an out-of-band digital signal, or by any other suitable data transmission technique. Program schedule data and other media guidance data may be provided to user equipment on multiple analog or digital television channels.

In some embodiments, guidance data from media guidance data source 418 may be provided to users' equipment using a client-server approach. For example, a user equipment device may pull media guidance data from a server, or a server may push media guidance data to a user equipment device. In some embodiments, a guidance application client residing on the user's equipment may initiate sessions with source 418 to obtain guidance data when needed, e.g., when the guidance data is out of date or when the user equipment device receives a request from the user to receive data. Media guidance may be provided to the user equipment with any suitable frequency (e.g., continuously, daily, a user-specified period of time, a system-specified period of time, in response to a request from user equipment, etc.). Media guidance data source 418 may provide user equipment devices 402, 404, and 406 the media guidance application itself or software updates for the media guidance application.

In some embodiments, the media guidance data may include viewer data. For example, the viewer data may include current and/or historical user activity information (e.g., what content the user typically watches, what times of day the user watches content, whether the user interacts with a social network, at what times the user interacts with a social network to post information, what types of content the user typically watches (e.g., pay TV or free TV), mood, brain activity information, etc.). The media guidance data may also include subscription data. For example, the subscription data may identify to which sources or services a given user subscribes and/or to which sources or services the given user has previously subscribed but later terminated access (e.g., whether the user subscribes to premium channels, whether the user has added a premium level of services, whether the user has increased Internet speed). In some embodiments, the viewer data and/or the subscription data may identify patterns of a given user for a period of more than one year. The media guidance data may include a model (e.g., a survivor model) used for generating a score that indicates a likelihood a given user will terminate access to a service/source. For example, the media guidance application may process the viewer data with the subscription data using the model to generate a value or score that indicates a likelihood of whether the given user will terminate access to a particular service or source. In particular, a higher score may indicate a higher level of confidence that the user will terminate access to a particular service or source. Based on the score, the media guidance application may generate promotions and advertisements that entice the user to keep the particular service or source indicated by the score as one to which the user will likely terminate access.

Media guidance applications may be, for example, stand-alone applications implemented on user equipment devices. For example, the media guidance application may be implemented as software or a set of executable instructions which may be stored in storage 308, and executed by control circuitry 304 of a user equipment device 300. In some embodiments, media guidance applications may be client-server applications where only a client application resides on the user equipment device, and server application resides on a remote server. For example, media guidance applications may be implemented partially as a client application on control circuitry 304 of user equipment device 300 and partially on a remote server as a server application (e.g., media guidance data source 418) running on control circuitry of the remote server. When executed by control circuitry of the remote server (such as media guidance data source 418), the media guidance application may instruct the control circuitry to generate the guidance application displays and transmit the generated displays to the user equipment devices. The server application may instruct the control circuitry of the media guidance data source 418 to transmit data for storage on the user equipment. The client application may instruct control circuitry of the receiving user equipment to generate the guidance application displays.

Content and/or media guidance data delivered to user equipment devices 402, 404, and 406 may be over-the-top (OTT) content. OTT content delivery allows Internet-enabled user devices, including any user equipment device described above, to receive content that is transferred over the Internet, including any content described above, in addition to content received over cable or satellite connections. OTT content is delivered via an Internet connection provided by an Internet service provider (ISP), but a third party distributes the content. The ISP may not be responsible for the viewing abilities, copyrights, or redistribution of the content, and may only transfer IP packets provided by the OTT content provider. Examples of OTT content providers include YOUTUBE, NETFLIX, and HULU, which provide audio and video via IP packets. Youtube is a trademark owned by Google Inc., Netflix is a trademark owned by Netflix Inc., and Hulu is a trademark owned by Hulu, LLC. OTT content providers may additionally or alternatively provide media guidance data described above. In addition to content and/or media guidance data, providers of OTT content can distribute media guidance applications (e.g., web-based applications or cloud-based applications), or the content can be displayed by media guidance applications stored on the user equipment device.

Media guidance system 400 is intended to illustrate a number of approaches, or network configurations, by which user equipment devices and sources of content and guidance data may communicate with each other for the purpose of accessing content and providing media guidance. The embodiments described herein may be applied in any one or a subset of these approaches, or in a system employing other approaches for delivering content and providing media guidance. The following four approaches provide specific illustrations of the generalized example of FIG. 4.

In one approach, user equipment devices may communicate with each other within a home network. User equipment devices can communicate with each other directly via short-range point-to-point communication schemes described above, via indirect paths through a hub or other similar device provided on a home network, or via communications network 414. Each of the multiple individuals in a single home may operate different user equipment devices on the home network. As a result, it may be desirable for various media guidance information or settings to be communicated between the different user equipment devices. For example, it may be desirable for users to maintain consistent media guidance application settings on different user equipment devices within a home network, as described in greater detail in Ellis et al., U.S. Patent Publication No. 2005/0251827, filed Jul. 11, 2005. Different types of user equipment devices in a home network may also communicate with each other to transmit content. For example, a user may transmit content from user computer equipment to a portable video player or portable music player.

In a second approach, users may have multiple types of user equipment by which they access content and obtain media guidance. For example, some users may have home networks that are accessed by in-home and mobile devices. Users may control in-home devices via a media guidance application implemented on a remote device. For example, users may access an online media guidance application on a website via a personal computer at their office, or a mobile device such as a PDA or web-enabled mobile telephone. The user may set various settings (e.g., recordings, reminders, or other settings) on the online guidance application to control the user's in-home equipment. The online guide may control the user's equipment directly, or by communicating with a media guidance application on the user's in-home equipment. Various systems and methods for user equipment devices communicating, where the user equipment devices are in locations remote from each other, is discussed in, for example, Ellis et al., U.S. Pat. No. 8,046,801, issued Oct. 25, 2011, which is hereby incorporated by reference herein in its entirety.

In a third approach, users of user equipment devices inside and outside a home can use their media guidance application to communicate directly with content source 416 to access content. Specifically, within a home, users of user television equipment 402 and user computer equipment 404 may access the media guidance application to navigate among and locate desirable content. Users may also access the media guidance application outside of the home using wireless user communications devices 406 to navigate among and locate desirable content.

In a fourth approach, user equipment devices may operate in a cloud computing environment to access cloud services. In a cloud computing environment, various types of computing services for content sharing, storage or distribution (e.g., video sharing sites or social networking sites) are provided by a collection of network-accessible computing and storage resources, referred to as “the cloud.” For example, the cloud can include a collection of server computing devices, which may be located centrally or at distributed locations, that provide cloud-based services to various types of users and devices connected via a network such as the Internet via communications network 414. These cloud resources may include one or more content sources 416 and one or more media guidance data sources 418. In addition or in the alternative, the remote computing sites may include other user equipment devices, such as user television equipment 402, user computer equipment 404, and wireless user communications device 406. For example, the other user equipment devices may provide access to a stored copy of a video or a streamed video. In such embodiments, user equipment devices may operate in a peer-to-peer manner without communicating with a central server.

The cloud provides access to services, such as content storage, content sharing, or social networking services, among other examples, as well as access to any content described above, for user equipment devices. Services can be provided in the cloud through cloud computing service providers, or through other providers of online services. For example, the cloud-based services can include a content storage service, a content sharing site, a social networking site, or other services via which user-sourced content is distributed for viewing by others on connected devices. These cloud-based services may allow a user equipment device to store content to the cloud and to receive content from the cloud rather than storing content locally and accessing locally-stored content.

A user may use various content capture devices, such as camcorders, digital cameras with video mode, audio recorders, mobile phones, and handheld computing devices, to record content. The user can upload content to a content storage service on the cloud either directly, for example, from user computer equipment 404 or wireless user communications device 406 having content capture feature. Alternatively, the user can first transfer the content to a user equipment device, such as user computer equipment 404. The user equipment device storing the content uploads the content to the cloud using a data transmission service on communications network 414. In some embodiments, the user equipment device itself is a cloud resource, and other user equipment devices can access the content directly from the user equipment device on which the user stored the content.

Cloud resources may be accessed by a user equipment device using, for example, a web browser, a media guidance application, a desktop application, a mobile application, and/or any combination of access applications of the same. The user equipment device may be a cloud client that relies on cloud computing for application delivery, or the user equipment device may have some functionality without access to cloud resources. For example, some applications running on the user equipment device may be cloud applications, i.e., applications delivered as a service over the Internet, while other applications may be stored and run on the user equipment device. In some embodiments, a user device may receive content from multiple cloud resources simultaneously. For example, a user device can stream audio from one cloud resource while downloading content from a second cloud resource. Or a user device can download content from multiple cloud resources for more efficient downloading. In some embodiments, user equipment devices can use cloud resources for processing operations such as the processing operations performed by processing circuitry described in relation to FIG. 3.

As referred herein, the term “in response to” refers to initiated as a result of. For example, a first action being performed in response to another action may include interstitial steps between the first action and the second action. As referred herein, the term “directly in response to” refers to caused by. For example, a first action being performed directly in response to another action may not include interstitial steps between the first action and the second action.

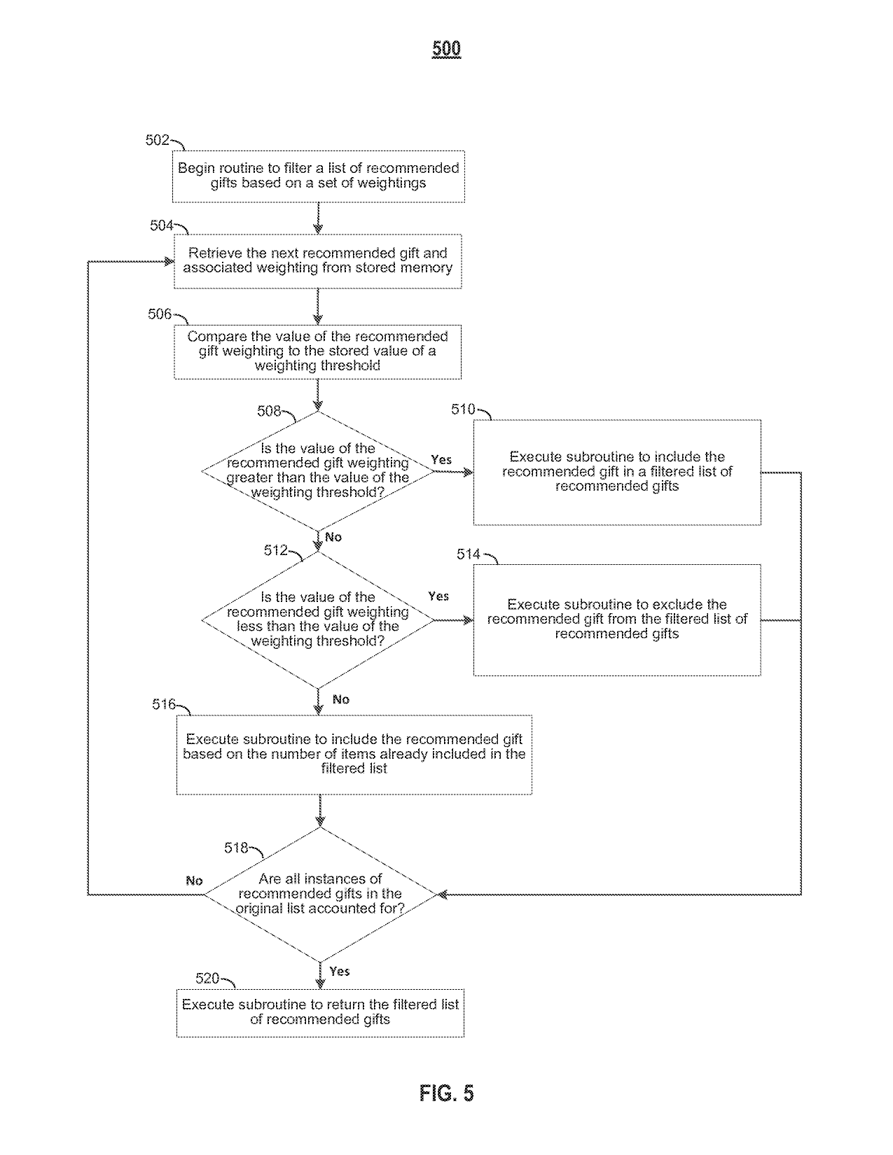

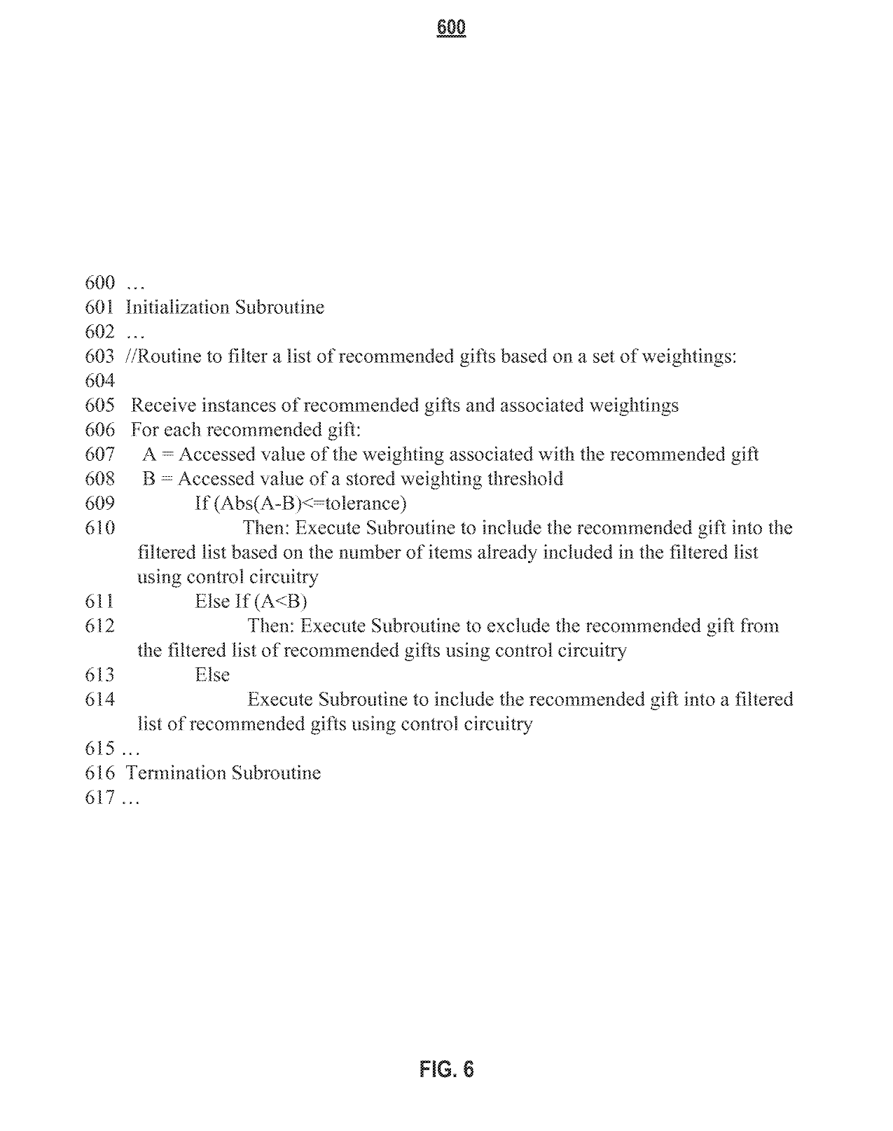

FIGS. 5 and 6 present an algorithm for control circuitry (e.g., control circuitry 304) to filter a list of recommended gifts based on a set of weightings, in accordance with some embodiments of the disclosure. In some embodiments this algorithm may be encoded on to non-transitory storage medium (e.g., storage 308) as a set of instructions to be decoded and executed by processing circuitry (e.g., processing circuitry 306). Processing circuitry may in turn provide instructions to other sub-circuits contained within control circuitry 304, such as the tuning, video generating, encoding, decoding, encrypting, decrypting, scaling, analog/digital conversion circuitry, and the like.

The flowchart in FIG. 5 describes an algorithm for control circuitry (e.g., control circuitry 304) to filter a list of recommended gifts based on a set of weightings in accordance with some embodiments of the disclosure.

At step 502, the algorithm to filter a list of recommended gifts based on a set of weightings will begin after a media guidance application retrieves a set of recommended gifts from a recommendation database. In some embodiments, this may be done either directly or indirectly in response to a user action or input (e.g., from signals received by control circuitry 304 or user input interface 310). For example, the algorithm may begin directly in response to control circuitry 304 receiving signals from user input interface 310 indicating a request for the media guidance application to provide gift recommendations for a user. Alternately, control circuitry 304 may prompt the user to confirm their input using a display (e.g., by generating a prompt to be displayed on display 312) prior to running the algorithm.

At step 504, control circuitry 304 proceeds to retrieve the next recommended gift and associated weighting from stored memory. In some embodiments control circuitry 304 may receive a single primitive data structure that represents the value of the weighting. In some embodiments the value may be stored as part of a larger data structure, and control circuitry 304 may retrieve the value by executing appropriate accessor methods to retrieve the value from the larger data structure. For example, the weighting may be stored as part of a larger data structure that contains information about the gift and attributes associated with the gift.

At step 506, control circuitry 304 proceeds to compare the value of recommended gift weighting to the stored value of a weighting threshold. In some embodiments, the weighting threshold may be stored (e.g., on storage device 308) prior to beginning the algorithm. In some embodiments the stored value of a weighting threshold may be periodically updated as recommended gifts are evaluated. In some embodiments, control circuitry 304 may directly compare the value of a weighting threshold with the value of a recommended gift weighting. In some instances, control circuitry 304 may call a comparison function (e.g., encapsulated within a class or data structure that represents the recommended gift) to compare the recommended gift weighting to the weighting threshold.

At step 508, control circuitry 304 compares the values of recommended gift weighting and the weighting threshold to determine if the value of the recommended gift weighting is greater than the value of the weighting threshold. If the condition is satisfied, the algorithm may proceed to step 510; if the condition is not satisfied, the algorithm may proceed to step 512 instead.

At step 510, control circuitry 304 will execute a subroutine to include the recommended gift in a filtered list of recommended gifts based on the condition at step 508 being satisfied. For example, in some embodiments the media guidance application may store the list of recommended gifts as an array of pointers to recommended gift objects. In this case the media guidance application may use a second array of Boolean variables with the same length as the first array to track gifts that will be included in the filtered list. For instance, after determining that the recommended gift referenced by the pointer in index 2 is to be included in the filtered list, the media guidance application may set the bool at index 2 of the second array to “TRUE.” In this situation, the algorithm may generate the filtered list as a new array at step 520. In some embodiments the media guidance application may store the list of recommended gifts as nodes within a double-linked list. In this case, a recommended gift to be included in the filtered list may be left unaltered, or a flag contained within the node may be changed to indicate that the recommended gift has already been evaluated. After the subroutine is executed, the algorithm may proceed to step 518 where it is determined if all instances of recommended gifts in the original list are accounted for and further iterations are needed.

At step 512, control circuitry 304 compares the values of the recommended gift weighting and the weighting threshold to determine if the value of the recommended gift weighting is less than the value of the weighting threshold. If the condition is satisfied, the algorithm may proceed to step 514; if the condition is not satisfied, the algorithm may proceed to step 516 instead.

At step 514, control circuitry 304 will execute a subroutine to exclude the recommended gift from the filtered list of recommended gifts based on the condition of step 512 being satisfied. Similar to the discussion for step 510, the exact method used may depend on how the media guidance application stores the list of recommended gifts. For example, if the list of recommended gifts are stored as a double-linked list, the media guidance application may remove the node representing the recommended gift that is to be excluded from the filtered list by changing the pointers of the adjacent nodes and freeing memory by then destructing the removed node. After the subroutine is executed, the algorithm may proceed to step 518 where it is determined if all instances of recommended gifts in the original list are accounted for.

At step 516, control circuitry 304 will execute a subroutine to include the recommended gift based on the number of items already included in the list, based on both of the conditions in 508 and 512 not being satisfied. For example, if the filtered list currently contains no gifts, the media guidance application may include a recommended gift in the filtered list in the special case where the recommended gift weighting is equal to the weighting threshold. After the subroutine is executed, the algorithm may proceed to 518 where it is determined if all instances of recommended gifts in the original list are accounted for.

At step 518, control circuitry 304 will check if all instances of recommended gifts in the original list are accounted for. For example, if the list of recommended gifts is implemented as a double-linked list, control circuitry 304 may call a function to see if there is a next node that has not been evaluated. If the function returns true (i.e., there are still instances that need to be processed), control circuitry 304 may proceed to step 504. For example, if the original list of recommended gifts contained 10 elements, the algorithm will not terminate until all 10 have been evaluated. If all of the instances have been evaluated, control circuitry 304 may proceed to step 520.

At step 520, control circuitry 304 will execute a subroutine to return the filtered list of recommended gifts. For example, if the list of recommended gifts was implemented as a double-linked list, and gifts to be excluded from the filtered list were removed from the double-linked list, control circuitry 304 may return a pointer to the head node.

It is contemplated that the descriptions of FIG. 5 may be used with any other embodiment of this disclosure. In addition, the descriptions described in relation to the algorithm of FIG. 5 may be done in alternative orders or in parallel to further the purposes of this disclosure. For example, conditional statements and logical evaluations, such as those at 508 and 512, may be performed in any order or in parallel or simultaneously to reduce lag or increase the speed of the system or method. As a further example, in some embodiments several instances of recommended gifts from the original list may be evaluated in parallel, using multiple logical processor threads, or the algorithm may be enhanced by incorporating branch prediction. Furthermore, it should be noted that the algorithm of FIG. 5 may be implemented on a combination of appropriately configured software and hardware, and that any of the devices or equipment discussed in relation to FIGS. 3-4 could be used to implement one or more portions of the algorithm.

The pseudocode in FIG. 6 describes an algorithm to filter a list of recommended gifts based on a set of weightings in accordance with some embodiments of the disclosure. It will be evident to one skilled in the art that the algorithm described by the pseudocode in FIG. 6 may be implemented in any number of programming languages and a variety of different hardware, and that the style and format should not be construed as limiting, but rather a general template of the steps and procedures that would be consistent with code used to implement some embodiments of this disclosure.

At line 601, the algorithm may run a subroutine to initialize variables and prepare to filter a list of recommended gifts based on a set of weightings, which begins on line 605. For example, in some embodiments control circuitry 304 may copy instructions from non-transitory storage medium (e.g., storage device 308) into RAM or into the cache for processing circuitry 306 during the initialization stage. Additionally, in some embodiments the value of a weighting threshold being used for comparison, or a tolerance level for determining if two values are essentially equivalent, may be retrieved, set, and stored at 601. In some embodiments the weightings may have been generated by a media guidance application based on comparing gift attributes associated with the recommended gifts with one or more user profiles.

At line 605, control circuitry 304 may receive instances of recommended gifts and associated weightings. In some embodiments these instances may be retrieved from stored memory. Control circuitry 304 may receive instances of recommended gift weightings by receiving, for example, a pointer to an array of values of recommended gift weighting. In another example, control circuitry 304 may receive a list of recommended gift objects or data structures, each one containing a field for the recommended gift weighting of the recommended gift.

At line 606, control circuitry 304 may iterate through the various instances of recommended gifts, if only a single instance is available, the loop will only execute once. This loop may be implemented several ways depending on the choice of hardware and software language used to implement the algorithm of FIG. 6. For example, this may be implemented as part of a “for” or “while” loop.

At line 607, control circuitry 304 will store the value of the recommended gift weighting into a temporary variable “A.” In some embodiments the value of the recommended gift weighting will be stored as part of a larger data structure or class, and the value of the recommended gift weighting may be obtained through appropriate accessor methods. In some embodiments the recommended gift weighting may be converted from a string or other non-numeric data type into a numeric data type by means of an appropriate hashing algorithm. In some embodiments, control circuitry 304 may call a function to perform a comparison of the recommended gift weighting to the weighting threshold. In some embodiments the recommended gift weighting may be encoded as a primitive data structure, and rather than using a temporary variable, recommended gift weighting may be directly used in the comparisons at lines 609 and 611.

At line 608, control circuitry 304 will store the value of the weighting threshold into a temporary variable “B.” Similar to the recommended gift weighting, in some embodiments the value of the weighting threshold will be stored as part of a larger data structure or class, and the value of the weighting threshold may be obtained through accessor methods. In some embodiments the weighting threshold may be converted from a string or other non-numeric data type into a numeric data type by means of an appropriate hashing algorithm, or the weighting threshold may be a primitive data structure, and may be directly used in the comparisons at lines 609 and 611.

At line 609, control circuitry 304 compares the value of A to the value of B to see if they are essentially equivalent. This is achieved by subtracting the value of B from A, taking the absolute value of the difference, and then comparing the absolute value of the difference to a predetermined tolerance level. In some embodiments the tolerance level may be a set percentage of either A or B. In some embodiments the tolerance level may be a fixed number. For example, setting the tolerance level to a set multiple of machine epsilon may allow for the algorithm to account for small rounding errors that may result from the use of floating point arithmetic. In some embodiments the tolerance level may be set to zero, or the condition inside the IF statement may be replaced with a strict equivalence between A and B.

At line 610, control circuitry 304 will execute a subroutine to include the recommended gift into the filtered list based on the number of items already included in the filtered list using control circuitry 304 if the condition in line 609 is satisfied. For example, if the recommended gift weighting is approximately equal to the weighting threshold, the media guidance application may only include the recommended gift in the filtered list if the list is currently empty.

At line 611, control circuitry 304 will compare the value of A and B to determine if A is less than B. In some embodiments this comparison will only be done if A is not approximately equal to B and the comparison in line 609 evaluates to FALSE. If the condition is satisfied, the algorithm proceeds to line 612.

At line 612, control circuitry 304 will execute a subroutine to exclude the recommended gift from the filtered list of recommended gifts using control circuitry 304 if the condition in line 611 is satisfied. For example, if the recommended gift weighting is substantially less than the weighting threshold, the media guidance application may not include the recommended gift in the filtered list.

At line 613, control circuitry 304 will determine whether neither condition in line 609 or 611 are satisfied. If neither condition is satisfied, then the instruction at line 614 may be evaluated and executed.

At line 614, control circuitry 304 will execute a subroutine to include the recommended gift into a filtered list of gift recommendations using control circuitry if neither of the conditions at lines 609 or 611 are satisfied. For example, line 614 may only be reached if the media guidance application determines that the recommended gift weighting is substantially larger than the weighting threshold, and the media guidance application will include the recommended gift in the filtered list.

At line 616, control circuitry 304 may run a termination subroutine after the algorithm has performed its primary function. For example, in some embodiments control circuitry 304 may destruct variables, perform garbage collection, free memory or clear the cache of processing circuitry 306. As part of the termination subroutine, control circuitry 304 may execute instructions to present the filtered list of gift recommendations to a user as a curated list of gift recommendations.

It will be evident to one skilled in the art that the algorithm described by the pseudocode in FIG. 6 may be implemented in any number of programming languages and a variety of different hardware, and the particular choice and location of primitive functions, logical evaluations, and function evaluations are not intended to be limiting. It will also be evident that the code may be refactored or rewritten to manipulate the order of the various logical evaluations, perform several iterations in parallel rather than in a single iterative loop, or to otherwise manipulate and optimize run-time and performance metrics without fundamentally changing the inputs or final outputs. For example, in some embodiments break conditions may be placed after lines 610 and 612 to speed operation, or the conditional statements may be replaced with a case-switch. In some embodiments, rather than iterating over all instances of the recommended gifts at step 506 sequentially, the code may be rewritten so control circuitry 304 is instructed to evaluate multiple instances of recommended gifts simultaneously on a plurality of processors or processor threads, lowering the number of iterations needed and potentially speeding up computation time.

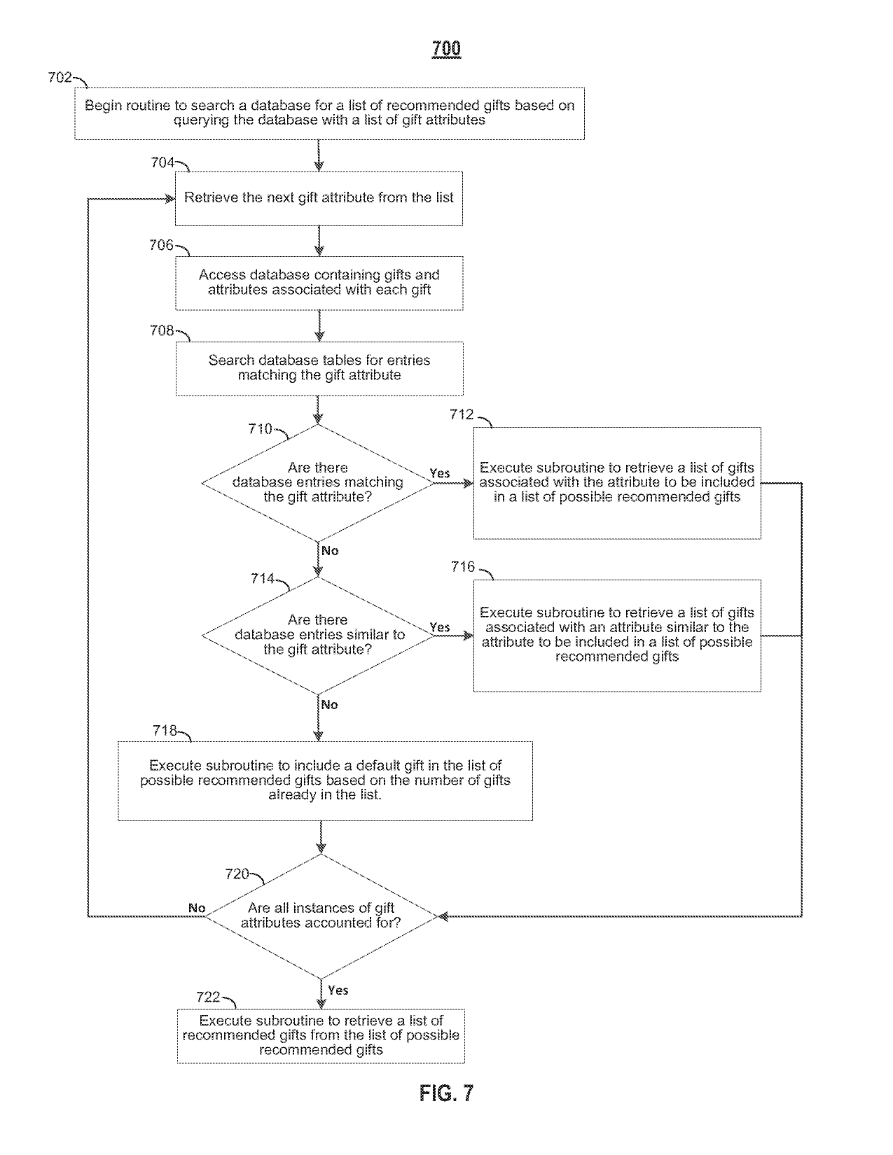

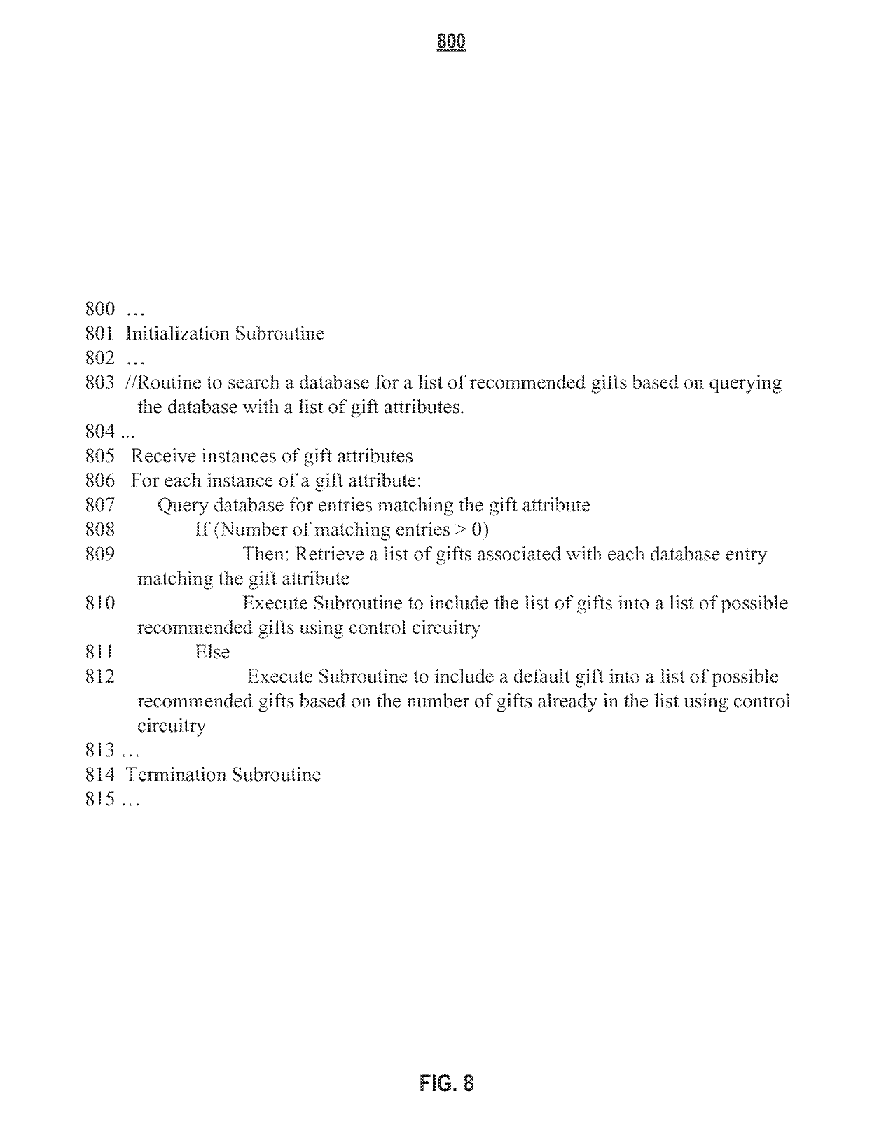

FIGS. 7 and 8 present an algorithm for control circuitry (e.g., control circuitry 304) to search a database for a list of recommended gifts based on querying the database with a list of gift attributes, in accordance with some embodiments of the disclosure. Similar to the algorithms described by FIGS. 5 and 6, in some embodiments this algorithm may be encoded on to non-transitory storage medium (e.g., storage device 308) as a set of instructions to be decoded and executed by processing circuitry (e.g., processing circuitry 306). Processing circuitry may in turn provide instructions to other sub-circuits contained within control circuitry 304, such as the tuning, video generating, encoding, decoding, encrypting, decrypting, scaling, analog/digital conversion circuitry, and the like.

The flowchart in FIG. 7 describes an algorithm for control circuitry (e.g., control circuitry 304) to search a database and retrieve a list of recommended gifts in accordance with some embodiments of the disclosure.

At step 702, control circuitry 304 searches a database and retrieve a list of recommended gifts will begin based on a media guidance application receiving a request to provide gift recommendations associated with a particular attribute. In some embodiments, this may be done either directly or indirectly in response to a user action or input (e.g., from signals received by control circuitry 304 or user input interface 310 indicative of a user request).

At step 704, control circuitry 304 proceeds to retrieve the next instance of a gift attribute from the list. In some embodiments control circuitry 304 may retrieve a single data structure that represents the value of gift attribute. For example, the gift attributes may be encoded using identifiers, so the attribute “related to fishing” may be encoded into the string “Wlkmwc12” for the purposes of communicating the attribute between the media guidance application and the database. In some embodiments control circuitry 304 may retrieve the value from a larger class or data structure, or stored as part of a larger list containing multiple gift attributes. For example, each attribute may be stored as part of an attribute and importance level pair.

At step 706, control circuitry 304 accesses a database containing gifts and attributes associated with each gift. In some embodiments, this database may be stored locally (e.g., on storage device 308) prior to beginning the algorithm. In some embodiments the database may also be accessed by using communications circuitry to transmit information across a communications network (e.g., communications network 414) to a database implemented on a remote storage device (e.g., media guidance data source 418). In some embodiments, the database itself may be part of the media guidance data retrievable from media guidance data source 418.

At step 708, control circuitry 304 searches database tables for entries matching the gift attribute. In some embodiments this may be done by comparing an identifier, for example, a string or integer representing the gift attribute, to identifiers used inside the database. In some embodiments control circuitry 304 may submit a general query to the database for table entries matching the gift attribute, and control circuitry 304 may receive a list of indices or a data structure containing a portion of the database contents. In some embodiments, the database may implement a junction table that in turn cross-references entries from other databases. For example, a junction table may cross-reference a database of gifts, and a database of attributes. In some embodiments, this may allow control circuitry 304 to retrieve a list of gifts associated with a particular attribute, and also retrieve a list of attributes associated with a particular gift. In this case, control circuitry 304 may retrieve indices from the first database that in turn can be used to retrieve information from the second database. For example, control circuitry 304 may search a first database containing gift attributes to identify indices of a second database that contain gifts associated with the attribute. Although we may describe control circuitry 304 interacting with a single database for purposes of clarity, it is understood that the algorithm of FIG. 7 may be implemented using multiple independent or cross-referenced databases.

At step 710, control circuitry 304 determines if there are database entries matching the gift attribute. In some embodiments control circuitry 304 may receive a signal from the database indicating that there are no matching entries. In some embodiments control circuitry 304 may instead receive a list of indices or data structures with a NULL or dummy value. If control circuitry 304 identifies that there are database entries matching the gift attribute the algorithm proceeds to step 712, otherwise the algorithm proceeds to step 714.

At step 712, control circuitry 304 will execute a subroutine to retrieve a list of gifts associated with the attribute to be included in a list of possible gift recommendations. For example, control circuitry 304 may search a first database containing gift attributes and retrieve a list of indices of a second database that contain gifts associated with the attribute. Control circuitry 304 may then retrieve the list of gifts directly from the second database. In some embodiments the media guidance application may use control circuitry 304 to retrieve other information from the database, such as a full list of attributes associated with the gift, or a set of relevance levels indicating how closely related each attribute is to the gift. Afterwards, the algorithm may proceed to step 720 where it is determined if there are further instances of gift attributes that need to be accounted for.

At step 714, control circuitry 304 determines if there are database entries similar to the gift attribute. For example, in some embodiments, if the gift attribute is encoded as a string with multiple characters, control circuitry 304 may perform additional database queries for similar strings with individual characters replaced, removed or added. In some embodiments control circuitry 304 may also determine if the original query was a commonly misspelled word, and will submit a query with the correct spelling instead. In another example, gift attribute may be encoded as an integer; control circuitry 304 may perform additional queries for other integers within a certain range. For example, closely related attributes such as “Horror,” “Terror,” “Scary,” and “Demonic,” may be encoded using sequential integers within the database. In some embodiments control circuitry 304 may retrieve database entries similar to, gift attribute without requiring further queries, particularly, when using a sophisticated database or a database built on top of neural network technology or with cognitive computing capabilities. If control circuitry 304 identifies that there are database entries similar to the gift attribute the algorithm proceeds to step 716; otherwise the algorithm proceeds to step 718.

At step 716, control circuitry 304 will execute a subroutine to retrieve a list of gifts associated with an attribute similar to the attribute to be included in a list of possible recommended gifts. In some embodiments, the media guidance application may assign the gifts an initial weighting, and the initial weighting may be lower for gifts associated with only a similar attribute. Afterwards, the algorithm may proceed to step 720.

At step 718, control circuitry 304 will execute a subroutine to include a default gift in the list of possible recommended gifts based on the number of gifts already in the list, after determining that there were no matching database entries for the gift attribute. For example, if there are currently no gifts included in the list of possible recommended gifts, the media guidance application may use control circuitry 304 to include a temporary default gift. Afterwards, the algorithm may proceed to step 720.

At step 720, control circuitry 304 will determine if all instances of gift attributes included in the list are accounted for and if further iterations are needed. If further iterations are needed the algorithm will loop back to step 704 where control circuitry 304 will retrieve the next instance gift attribute. If no further iterations are needed the algorithm will proceed to step 722. In some embodiments, the media guidance application may receive a request to search based on a single attribute rather than a list of attributes, in which case control circuitry 304 may skip step 720 and proceed directly to step 722 instead.

At step 722, control circuitry 304 will execute a subroutine to retrieve a list of recommended gifts from the list of possible gift recommendations. For example, control circuitry 304 may remove a temporary default gift included at step 718 if other gifts had been included from steps 712 and 716, or control circuitry 304 may remove duplicate gifts that matched multiple gift attributes in the list. As an alternate example, control circuitry 304 may select only a subset of the possible recommended gifts, prioritizing gifts added at step 712 over gifts added at step 716. The total number of gifts selected to be included in the list of recommended gifts may also be based on available storage, the bandwidth and quality of the connection between the media guidance application and the database.

It is contemplated that the descriptions of FIG. 7 may be used with any other embodiment of this disclosure. In addition, the descriptions described in relation to the algorithm of FIG. 7 may be done in alternative orders or in parallel to further the purposes of this disclosure. For example, control circuitry 304 may submit multiple queries to the database in parallel, or it may submit multiple queries to a plurality of similar databases in order to reduce lag and speed the execution of the algorithm. As a further example, although step 712 and step 716 are described as being mutually exclusive, the system may proceed to step 714 directly after step 712, in order to include both gift related to an attribute, and gifts similar to the same attribute. To further this purpose, in some embodiments, step 710 and step 714 may be performed in parallel by control circuitry 304. Furthermore, it should be noted that the algorithm of FIG. 7 may be implemented on a combination of appropriately configured software and hardware, and that any of the devices or equipment discussed in relation to FIGS. 3-4 could be used to implement one or more portions of the algorithm.

The pseudocode in FIG. 8 describes an algorithm to search a database for a list of recommended gifts based on querying the database with a list of gift attributes, in accordance with some embodiments of the disclosure. It will be evident to one skilled in the art that the algorithm described by the pseudocode in FIG. 8 may be implemented in any number of programming languages and a variety of different hardware, and that the style and format should not be construed as limiting, but rather a general template of the steps and procedures that would be consistent with code used to implement some embodiments of this disclosure.

At line 801, control circuitry 304 runs a subroutine to initialize variables and prepare to search a database for a list of recommended gifts based on querying the database with a list of gift attributes, which begins on line 805. For example, in some embodiments control circuitry 304 may copy instructions from non-transitory storage medium (e.g., storage device 308) into RAM or into the cache for processing circuitry 306 during the initialization stage. Prior to running the algorithm, a media guidance application may receive a user request to provide a curated list of gift recommendations to a second user based on an attribute.

At line 805, control circuitry 304 receives instances of gift attributes. In some embodiments these instances may be retrieved from memory, or from user input. For example, a media guidance application may receive a request from a first user to provide gift recommendations for a second user, wherein the request comprises one or more gift attributes and an identity of the second user. The media guidance application may then use control circuitry 304 to extract the gift attributes from the request.

At line 806, control circuitry 304 iterates through the various instances of gift attributes; if only a single instance is available, the loop will only execute once. This loop may be implemented in multiple fashions depending on the choice of hardware and software language used to implement the algorithm of FIG. 8. For example, this may be implemented as part of a “for” or “while” loop, in some programming languages. In some embodiments it may be convenient to store multiple instances of gift attributes in a single class or encapsulated data structure that will perform the loop as part of an internal method.

At line 807, control circuitry 304 may query a database for entries matching the gift attribute. Depending on how the database is implemented, and how the gift attribute is stored, an intermittent step may be required to convert gift attribute into a form consistent with the database. For example, the media guidance application may use control circuitry 304 to encode the gift attribute into a string or an integer using an appropriate hashing algorithm prior to being transmitted to the database by control circuitry 304 as part of a query. After querying the database, control circuitry 304 may retrieve a set of database entries matching the gift attribute. In some embodiments control circuitry 304 may receive these entries in the form of a data-structure, a set of indices of the database, or a set of indices of another cross-referenced database.

At line 808, control circuitry 304 will determine if there are any database entries matching the gift attribute. In some embodiments control circuitry 304 may determine this by checking if the database returned an empty data structure or a NULL value in response to the query in line 807. If there are matching database entries the algorithm may proceed to line 809. If there were no matching database entries the algorithm may instead proceed to line 812.

At line 809, control circuitry 304 may retrieve one or more gifts associated with the database entries matching the gift attribute. For example, if control circuitry 304 retrieves a list of indices within a gift database associated with the attribute used in the database query in line 807, control circuitry 304 may then access the gift database and retrieve the gifts located at those indices. In some embodiments, the indices may point to a larger data structure contained within the database, and control circuitry 304 may retrieve the gifts from within the data structure using appropriate accessor methods. In some embodiments control circuitry 304 may retrieve the gifts and store them in a separate data structure locally (e.g., in storage 308) prior to proceeding further. In some embodiments the gifts may be stored as a data structure containing information such as the gift name, a gift identifier, the gift type, a list of attributes and attribute relevance levels, and the like. After retrieving the gifts the algorithm will proceed to line 810.

At line 810, control circuitry 304 will execute a subroutine to include the retrieved gifts into a list of possible gift recommendations using control circuitry. For example, control circuitry 304 may add each of the retrieved gifts as nodes into a list of possible gift recommendations stored as a double-linked list. Afterwards, the algorithm may proceed to line 815.

At line 811, control circuitry 304 will have determined that there were no database entries matching the gift attribute. In this case, the algorithm will proceed to line 812.

At line 812, control circuitry 304 will execute a subroutine to include a default gift into a list of possible recommended gifts based on the number of gifts already in the list using control circuitry 304. For example, the media guidance application may use control circuitry 304 to determine if the list of possible gift recommendations is empty, and include a temporary default gift into the list. The media guidance application may choose the default gift at random, or it may be previously set by the first user. Afterwards, the algorithm may proceed to line 814.

At line 814, control circuitry 304 executes a termination subroutine after the algorithm has performed its function and all instances of gift attributes have been processed and checked against the database. For example, in some embodiments control circuitry 304 may destruct variables, perform garbage collection, free memory or clear the cache of processing circuitry 306.

It will be evident to one skilled in the art that the algorithm described by the pseudocode in FIG. 8 may be implemented in any number of programming languages and a variety of different hardware, and the particular choice and location of primitive functions, logical evaluations, and function evaluations are not intended to be limiting. It will also be evident that the code may be refactored or rewritten to manipulate the order of the various logical evaluations, perform several iterations in parallel rather than in a single iterative loop, or to otherwise manipulate and optimize run-time and performance metrics without fundamentally changing the inputs or final outputs. For example, in some embodiments the code may be re-written so control circuitry 304 is instructed to evaluate multiple instances of gift attributes and submit multiple database queries simultaneously using a plurality of processors or processor threads. It is also understood that although we may describe control circuitry 304 interacting with a single database, this is only a single embodiment described for illustrative purposes, and the algorithm of FIG. 8. may be implement using multiple independent or cross-referenced databases. For example, a database stored locally (e.g., on storage 308) may index or cross-reference a database stored remotely (e.g., media guidance data source 418), which may be accessible through any number of communication channels (e.g., communications network 414). In some embodiments, this may allow control circuitry 304 to utilize a look-up table or database front-end efficiently stored on a small local drive to access a larger database stored on a remote server and available on demand.

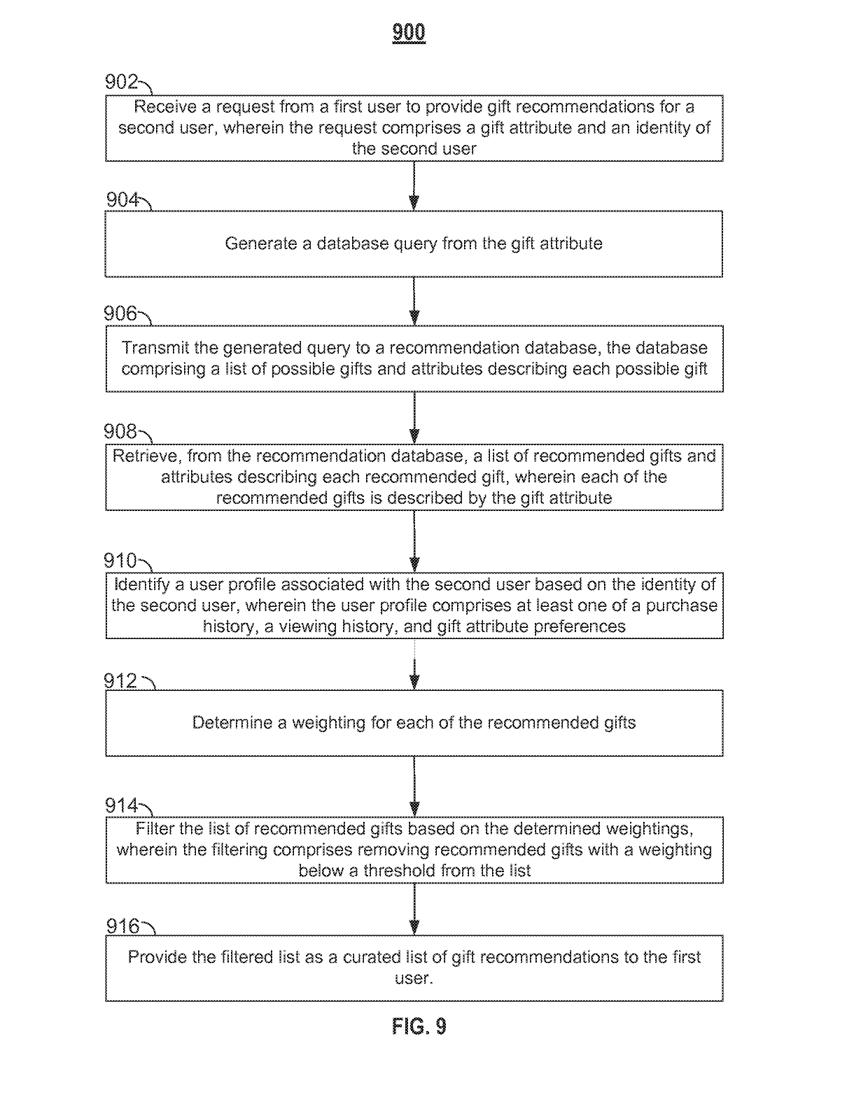

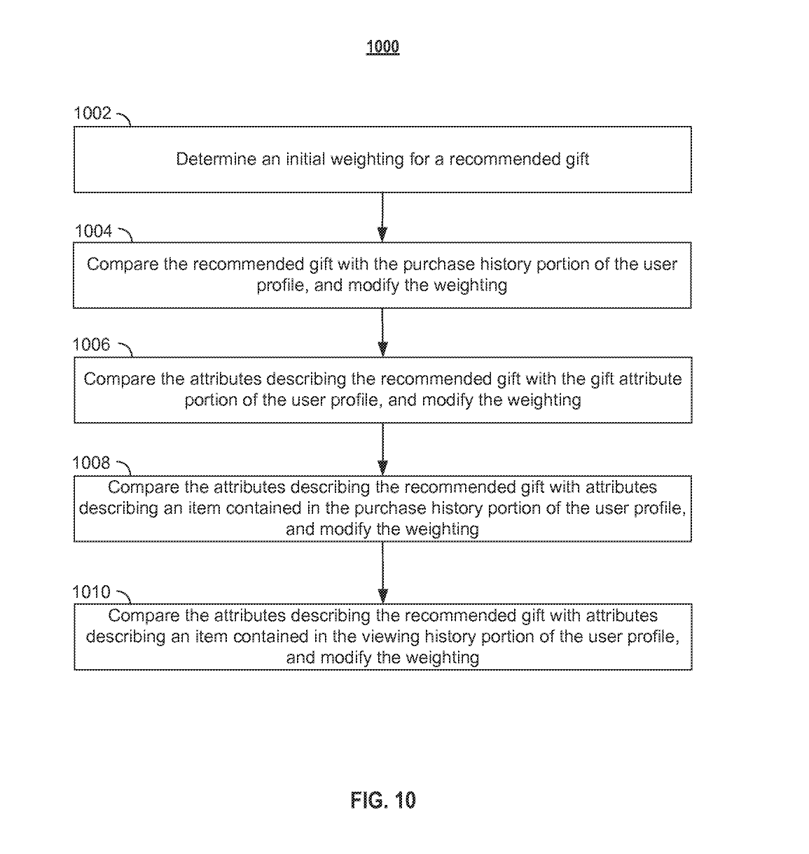

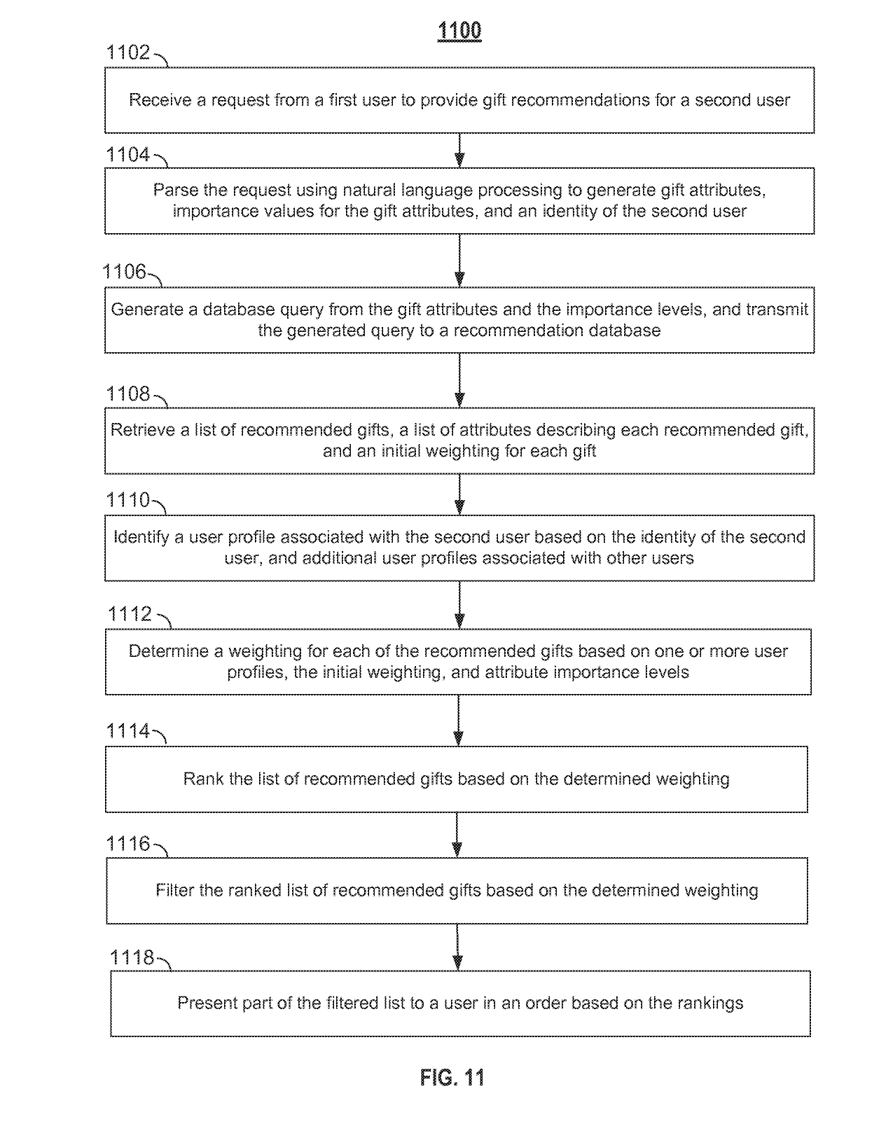

FIG. 9 is an illustrative block diagram of a method for providing a curated list of gift recommendations for users without querying the users or publicly disclosing information about the users, in accordance with some embodiments of the disclosure. It should be noted that process 900 or any step thereof could be performed on, or provided by, any of the devices shown in FIG. 3-4. For example, process 900 may be executed by control circuitry 304 (FIG. 3) as instructed by a media guidance application implemented on user equipment 402, 404, and/or 406 (FIG. 4). In addition, one or more steps of process 900 may be incorporated into or combined with one or more steps of any other process or embodiment (e.g., algorithm 500 (FIG. 5), algorithm 600 (FIG. 6), algorithm 700 (FIG. 7), algorithm 800 (FIG. 8), process 1000 (FIG. 10), or process 1100 (FIG. 11)).

In step 902, a media guidance application receives (e.g., via control circuitry 304 (FIG. 3)) a first user to provide gift recommendations for a second user, wherein the request comprises a gift attribute and an identity of the second user. In some embodiments, the media guidance application may receive a gift attribute entered by a user (e.g., from user input interface 310 (FIG. 3)) on user equipment 402, 404, and/or 406 (FIG. 4) along with a selection of a second user. For example, the media guidance application may receive a request from a user to provide gift recommendations for the user's husband related to the attribute “Medieval times.” In some embodiments the media guidance application may provide the first user with an interface (e.g., via display 312 (FIG. 3)) displaying available gift attributes and potential gift recipients. For example, the media guidance application may generate a display containing a list of friends associated with the first user on a social media service, and provide the first user with an opportunity to select one of the displayed friends as the second user.

In step 904, the media guidance application generates (e.g., via control circuitry 304 (FIG. 3)) a database query from the gift attribute. For example, the media guidance may use multiple databases to locate gift recommendations, each with their own syntax and API. The media guidance application may have templates for each of the databases stored beforehand (e.g., stored as plain text in storage 308 (FIG. 3). The media guidance application may identify the recommendation database that will be used (e.g., with control circuitry 304 (FIG. 3)) select the appropriate template from storage, and fill in the template with the gift attribute by inserting the gift attribute into the appropriate portion of the template.

In some embodiments, the media guidance application may convert the gift attribute into an alternate string or numerical value before filling in the template. For example, certain databases may store attributes in either an encoded format, or using certain conventions such as all lower case or camel caps. As part of the templates, the media guidance application may also have stored instructions for the appropriate way to format each string (e.g., using control circuitry 304).

In step 906, the media guidance application transmits (e.g., via control circuitry 304 (FIG. 3) over communications network 414 (FIG. 4)) the generated query to a recommendation database, the database comprising a list of possible gifts and attributes describing each possible gift. For example, the media guidance application may transmit the gift attribute “Medieval times” to the recommendation database as part of an appropriately formatted query.

In step 908, the media guidance application retrieves (e.g., via control circuitry 304 (FIG. 3) over communications network 414 (FIG. 4)), from the recommendation database, a list of recommended gifts and attributes describing each recommended gift, wherein each of the recommended gifts is described by the gift attribute. For example, the media guidance application may retrieve a set of gift recommendations associated with the attribute “Medieval times,” such as a DVD box set for the TV series “Camelot,” a digital rental for the film “Robin Hood: Men in Tights,” the book “A Connecticut Yankee in King Arthur's Court,” tickets for a local renaissance festival, replica swords and Medieval armaments, and the like. For each of the gifts, the media guidance application receives a list of attributes describing each gift. For example, the film “Robin Hood: Men in Tights” may be associated with the attributes “comedy” “parody” “Medieval times” “PG-13” “directed by Mel Brooks” and “archery.” In some embodiments, the media guidance application may receive each of the recommended gifts as a data structure that contains the name of the gift, an identifier associated with the gift, the type of the gift, a list of attributes associated with the gift, relevance levels indicating how well each attribute describes the gift, and the like. In some embodiments, the media guidance application may employ an algorithm modeled after algorithms 700 and 800 to retrieve, from the recommendation database, a list of recommended gifts and attributes describing each recommended gift.

In step 910, the media guidance application identifies (e.g., via control circuitry 304 (FIG. 3)) a user profile associated with the second user based on the identity of the second user, wherein the user profile comprises at least one of a purchase history, a viewing history, and gift attribute preferences. For example, if the media guidance application receives a link to the second user's profile page, the media guidance application may access the profile on that page. In some embodiments, the media guidance application may have access to multiple stored profiles or data about each user (e.g., stored in media guidance data on media guidance data source 418). The media guidance application may then transmit the identity of the second user (e.g., via control circuitry 304 (FIG. 3) over communications network 414 (FIG. 4)) to the media guidance data source and identify a user profile associated with the second user.

In step 912, the media guidance application determines (e.g., via control circuitry 304 (FIG. 3)) a weighting for each of the recommended gifts. For example, the media guidance application may assign each of the recommended gifts a weighting between 0 and 100, correlating to how desirable the second user may find the desired gift, based on the contents of the user profile associated with the second user. Methods for a media guidance application to use a profile to determine a weighting is elaborated on further in process 1000 (FIG. 10).

In step 914, the media guidance application filters (e.g., via control circuitry 304 (FIG. 3)) the list of recommended gifts based on the determined weightings, wherein the filtering comprises removing recommended gifts with a weighting below a threshold from the list. For example, the media guidance application may filter out gifts with a weighting below 70 by removing them from the list. In some embodiments, the media guidance application may modify the threshold to ensure that a predetermined number of gifts are included in the filtered list. In some embodiments, the media guidance application may employ an algorithm modeled after algorithms 500 and 600 to filter the list of recommended gifts based on the determined weightings.

In step 916, the media guidance application provides (e.g., via control circuitry 304 (FIG. 3) and display 312 (FIG. 3)) the filtered list as a curated list of gift recommendations to the first user. For example, the media guidance application may generate a display on user equipment 402, 404 and/or 406, containing the filtered list. In some embodiments, the media guidance application may store the filtered list (e.g., in storage 308) and provide users with the ability to access the filtered list at a later time.

It is contemplated that the steps or descriptions of FIG. 9 may be used with any other embodiment of this disclosure. In addition, the steps and descriptions described in relation to FIG. 9 may be done in alternative orders or in parallel to further the purposes of this disclosure. For example, performing steps in alternate order or in parallel may reduce the overall latency of the system, or allow a portion of the filtered list to be displayed constantly, with new items added and updated as more recommendations are retrieved and more weightings determined. Furthermore, it should be noted that any of the devices or equipment discussed in relation to FIGS. 3-4 could be used to perform one or more of the steps in FIG. 9.

FIG. 10 is an illustrative block diagram of a method for determining a weighting for a recommended gift, in accordance with some embodiments of the disclosure. It should be noted that process 1000 or any step thereof could be performed on, or provided by, any of the devices shown in FIGS. 3-4. For example, process 1000 may be executed by control circuitry 304 (FIG. 3) as instructed by a media guidance application implemented on user equipment 402, 404, and/or 406 (FIG. 4). In addition, one or more steps of process 1000 may be incorporated into or combined with one or more steps of any other process or embodiment (e.g., algorithm 500 (FIG. 5), algorithm 600 (FIG. 6), algorithm 700 (FIG. 7), algorithm 800 (FIG. 8), process 900 (FIG. 9), or process 1100 (FIG. 11)). For example, process 10 may be incorporated into step 912 of process 900 to determine the weighting for each of the recommended gifts.

In step 1002, the media guidance application determines (e.g., via control circuitry 304 (FIG. 3)) an initial weighting for a recommended gift. For example, prior to modifying the weighting based on the information contained in a user profile, the media guidance application may assign each of the recommended gifts a weighting of 50 as an initial weighting. In some embodiments, the media guidance application may also take a data-structure representing a recommended gift, and insert a new variable into the data-structure that represents the initial weighting.

In some embodiments, the media guidance application determines the initial weighting based on how relevant the recommended gift is to the original gift attribute contained in the request from the first user. For example, the media guidance application may receive from the recommendation database (e.g., via control circuitry 304 (FIG. 3) over communications network 414 (FIG. 4)), a relevance level for each of the attributes describing a recommended gift. The relevance level may be between 0 and 100, and correlate to how well the attribute describes the recommended gift. For example, if the gift attribute contained in the request was “Medieval times,” the documentary series “Medieval Lives” about the Medieval period may have a very high relevance level associated with the attribute, while the film “Dungeons and Dragons” takes place in a fictitious world and feature Medieval tropes such as knights and swordplay, but it may have a lower relevance level since it is not closely associated with the actual “Medieval times.” The media guidance application may then set the initial weighting proportional to the relevance level for the gift attribute contained in the request, thus giving a higher weight to recommended gifts that match the initial request.

In step 1004, the media guidance application compares (e.g., via control circuitry 304 (FIG. 3)) the recommended gift with the purchase history portion of the user profile, and modify the weighting. For example, if the recommended gift already exists in a purchase history associated with the user profile, the media guidance application may modify the weighting (e.g., via control circuitry 304 (FIG. 3)) by setting it equal to 0. In some embodiments, the media guidance application may also insert a flag into the data structure representing the recommended gift to denote that the weighting should not be modified further. Alternately, if the gift already exists in the purchase history, the media guidance application may set the weighting equal to zero, and skip steps 1006, 1008 and 1010 to save on computation time and effort.

In some embodiments the media guidance application determines (e.g., via control circuitry 304 (FIG. 3)) whether the recommended gift already exists in a purchase history associated with the user profile without directly accessing the purchase history. The media guidance application may transmit (e.g., over communications network 414 (FIG. 4)) the recommended gift, or data uniquely identifying the recommended gift, directly to a server hosting the user profile (e.g., media guidance data source 418 (FIG. 4)). The media guidance application may then receive a Boolean value (e.g., from the media guidance data source 418 (FIG. 4)) representing whether or not the gift exists in the purchase history. This may allow the user associated with the user profile to maintain his or her privacy, and not divulge the full contents of the purchase history.

In step 1006, the media guidance application compares (e.g., via control circuitry 304 (FIG. 3)) the attributes describing the recommended gift with the gift attribute portion of the user profile, and modify the weighting. The gift attribute portion of the user profile (e.g., contained as part of media guidance data in media guidance data source 418) may contain information such as attributes a user enjoys or doesn't enjoy, types of gifts that a user does not want to receive, attributes associated with recently received gifts, and the like. The media guidance application may then compare (e.g., via control circuitry 304 (FIG. 3)) each attribute associated with a recommended gift to the attribute preferences, and modify the weighting appropriately. For example, for each attribute that explicitly matches an attribute that the user enjoys, the media guidance application may increase the weighting by 10, up to a limit of 100. Conversely, for each attribute that explicitly matches an attribute that the user doesn't enjoy, the media guidance may reduce the weighting by 15, down to a lower limit of 0. In some embodiments, the attribute preferences may also comprise a value corresponding to how strong that preference is. For example, a user may greatly enjoy gifts associated with “science fiction”, but only mildly enjoy gifts associated with “fantasy.” In this case, the media guidance application may increase the weighting by a larger amount for recommended gifts associated with the “science fiction” attribute compared to gifts associated with the “fantasy” attribute.

In some embodiments, the media guidance application compares an attribute to the gift attribute preferences of the second user without directly accessing the gift attribute preferences of the second user. For example, the media guidance application may transmit (e.g., over communications network 414 (FIG. 4)) an attribute, or data uniquely identifying an attribute, directly to a server hosting the user profile (e.g., media guidance data source 418 (FIG. 4)). The media guidance application may then receive a positive or negative value (e.g., from the media guidance data source 418 (FIG. 4)) representing the attribute preferences for that attribute. For example, the media guidance application may transmit the attribute “science fiction” to the server, and retrieve back the change in the weighting “+15.” This may allow the user associated with the user profile to maintain their privacy, and not divulge the full contents of the attribute preferences.

In step 1008, the media guidance application compares (e.g., via control circuitry 304 (FIG. 3)) the attributes describing the recommended gift with attributes describing an item contained in the purchase history portion of the user profile, and modify the weighting. The media guidance application may aggregate together the attributes describing items in the purchase history, and store (e.g., in storage 308) information representing how often each attribute appears. For example, the media guidance application may determine an aggregated list indicating that the attribute “science fiction” appears 15 times, the attribute “fantasy” appears 7 times, and the attribute “fishing” appears 1 time. In some embodiments, this may be implemented using control circuitry 304 and storage 308 to form a hash table with each key representing an attribute and each value representing the number of times the attribute appeared in the purchase history. The media guidance application may compare each attribute describing a recommended gift with the aggregated list of attributes, and modify the weighting based on how popular an attribute is. For example, gifts associated with the “science fiction” attribute may have their weighting increased by 15, gifts associated with the “fantasy attribute” may have their weighting increased by 7, and gifts associated with the fishing attribute may have their weighting increased by 1.

In some embodiments the media guidance application may compare the attributes describing the recommended gift with attributes describing an item contained in the purchase history portion of the user profile without directly accessing the purchase history of the second user. For example, the media guidance application may transmit (e.g., over communications network 414 (FIG. 4)) an attribute, or data uniquely identifying an attribute, directly to a server hosting the user profile (e.g., media guidance data source 418 (FIG. 4)). The media guidance application may then receive a positive or negative value (e.g., from the media guidance data source 418 (FIG. 4)) indicating how popular that attribute is within the purchase history.

In step 1010, the media guidance application may compare (e.g., via control circuitry 304 (FIG. 3)) the attributes describing the recommended gift with attributes describing an item contained in the viewing history portion of the user profile, and modify the weighting. Similar to the discussion for step 1008, the media guidance application may aggregate together the attributes describing items in the viewing history, and store (e.g., in storage 308) information representing how often each attribute appears. For example, the media guidance application may determine an aggregated list indicating that the attribute “comedy” appears 5 times, the attribute “horror” appears 12 times, and the attribute “reality tv” appears 2 times. The media guidance application may compare (e.g., via control circuitry 304 (FIG. 3)) each attribute describing a recommended gift with the aggregated list of attributes, and modify the weighting based on how popular an attribute is. For example, gifts associated with the “horror” attribute may have their weighting increased, gifts associated with the “comedy” may have their weighting remain the same, and gifts associated with the fishing attribute may have their weighting reduced.

It is contemplated that the steps or descriptions of FIG. 10 may be used with any other embodiment of this disclosure. For example, the steps to determine a weighting could be integrated into step 912 of process 900 (FIG. 9). In addition, the steps and descriptions described in relation to FIG. 10 may be done in alternative orders or in parallel to further the purposes of this disclosure. For example, performing steps in alternate order or in parallel may reduce the overall latency of the system, allow the process to determine weightings more quickly, or allow weightings for multiple gifts to be determined simultaneously. As an alternate example, performing step 1004 last may guarantee that gifts that already exist in the purchase history have a low weighting, regardless of what the other portions of the user profile may indicate. Furthermore, it should be noted that any of the devices or equipment discussed in relation to FIGS. 3-4 could be used to perform one or more of the steps in FIG. 10.

FIG. 11 is an illustrative block diagram of a method for providing a curated list of gift recommendations based on multiple user profiles and parsing a user request using natural language processing, in accordance with some embodiments of the disclosure. It should be noted that process 1100 or any step thereof could be performed on, or provided by, any of the devices shown in FIG. 3-4. For example, process 1100 may be executed by control circuitry 304 (FIG. 3) as instructed by a media guidance application implemented on user equipment 402, 404, and/or 406 (FIG. 4). In addition, one or more steps of process 1100 may be incorporated into or combined with one or more steps of any other process or embodiment (e.g., algorithm 500 (FIG. 5), algorithm 600 (FIG. 6), algorithm 700 (FIG. 7), algorithm 800 (FIG. 8), process 900 (FIG. 9), or process 1000 (FIG. 10)).

In step 1102, the media guidance application receives (e.g., via control circuitry 304 (FIG. 3)) a request from a first user to provide gift recommendations for a second user. The request may be entered as text, audio, hand gestures, or any other convenient means (e.g., via user input interface 310 (FIG. 3). For example, the media guidance application may receive an audio request to “recommend a birthday gift for Angie related to horses,” as spoken by a user into a microphone (e.g., a microphone located on user equipment 402, 404, and/or 406 (FIG. 4)). The media guidance application may then convert the audio into text using speech recognition.

In some embodiments, the request may also contain images, location information, user profile information, or other data (e.g., data from media guidance data source 418 (FIG. 4)), or a combination of different types of input. For example, a media guidance application may receive a verbal request to “recommend something related to science fiction for the person in this photo,” along with an image of a person. The media guidance application may then use facial recognition to identify the person in the photo and determine the person's identity. In some embodiments, the media guidance application may also use a social network or list of persons associated with the first user to refine the search results from the facial recognition. As an alternate example, the media guidance application may receive a request to “recommend a lawn ornament for the person that across the street.” After applying natural language processing to interpret the request, the media guidance application may then use a combination of media guidance data (e.g., as provided by media guidance data source 418 (FIG. 4), and GPS (e.g., available from user equipment 402, 404, and 406 (FIG. 4)) to determine the intended recipient.

In step 1104, the media guidance application parses (e.g., via control circuitry 304 (FIG. 3)) the request using natural language processing to generate gift attributes, importance values for the gift attributes, and an identity of the second user. For example, the media guidance application may use control circuitry 304 to parse the phrase “recommend a birthday gift for Angie related to horses,” to determine different parts of speech, identify verbs and subjects, distinguish meaningful adjectives and adverbs, and determine that the phrase constitutes a well-formed request. In this example, the media guidance application may identify the verb “recommend” as designating a request, the phrase “for Angie” designates “Angie” as the second user intended to receive the gift, the phrase “related to” preceding the word “horses” designates “horses” as the most important attribute, and the adjective “birthday” modifying gift designates it as a less important attribute. In some embodiments, the media guidance application may also transmit the audio file, or a text version of the audio file, to a remote server (e.g., via communications network 414 (FIG. 4)) for processing. The remote server may then perform the natural language processing and parse the request, and return the result to the media guidance application.

In step 1106, the media guidance application generates (e.g., via control circuitry 304 (FIG. 3)) a database query from the gift attributes and the importance levels, and transmit the generated query to a recommendation database. The media guidance may use multiple databases to locate gift recommendations based on multiple gift attributes, each with their own syntax and API. The media guidance application may have special templates designed to accommodate multiple gift attributes and importance levels (e.g., stored as plain text in storage 308 (FIG. 3). For instance, the media guidance application may insert a table of the gift attributes and importance levels into the template, and transmit (e.g., via communications network 414 (FIG. 4) the modified template to the appropriate recommendation database.

In step 1108, the media guidance application retrieves (e.g., via control circuitry 304 (FIG. 3) and communications network 414 (FIG. 4)) a list of recommended gifts, a list of attributes describing each recommended gift, and an initial weighting for each gift. For example, the media guidance application may retrieve a set of gift recommendations that are associated with the “comedy” and “horror” attributes, with a greater importance being placed onto “comedy”. Gift recommendations strongly associated with both attribute, such as the comedy horror film “Tucker and Dale vs Evil,” may have a very high initial weighting. Strict comedy films with no horror element, such as the comedy film “Spaceballs,” may still have a high rating, but lower than the comedy horror films. Horror films with no comedic element, such as “The Silence of the Lambs,” may also be returned as recommended gifts, but they will be given a very low initial weighting. In some embodiments, the media guidance application may employ an algorithm modeled after algorithms 700 and 800 to retrieve, from the recommendation database, a list of recommended gifts and attributes describing each recommended gift.

In some embodiments, the weightings may be based on a combination of the importance levels associated with each attribute, and relevance levels indicating how well each attribute describes the gift. For example, a horror film with a limited comedic element, such as “Leprechaun 3,” may have a lower relevance level for the “comedy” attribute than a film with a stronger comedic element, such as “Leprechaun: Back 2 tha Hood.” As a result, despite the films both being associated with the “comedy” and “horror,” the more comedic film “Leprechaun: Back 2 tha Hood” may have a higher initial weighting.

In some embodiments, the media guidance application may determine the initial weighting based on the importance levels. For example, the media guidance application may receive a list of relevance levels indicating how well each attribute describes the gift. The media guidance application may then combine that information with the importance levels to determine the initial weighting.

In step 1110, the media guidance application identifies (e.g., via control circuitry 304 (FIG. 3)) a user profile associated with the second user based on the identity of the second user, and additional user profiles associated with other users. For example, if the media guidance application may receive a profile for the second user based on the identity provided in the request, and the media guidance application may also obtain a profile of the first user. Each profile may be obtained multiple ways, such as searching a database of profiles using a user's name, online pseudonym, or other identifying data. In some embodiments, a database (e.g., hosted on storage 308 (FIG. 3) or media guidance data source 418 (FIG. 4)) may aggregate together multiple user profiles, and the media guidance application may provide a key or signature associated with a user to access the stored user profiles associated with the user. For example, a user may share a signature or key with a friend via a media guidance application, and the media guidance application may use the signature or key to access a portion of the user profile associated with the user.

In step 1112, the media guidance application determines (e.g., via control circuitry 304 (FIG. 3)) a weighting for each of the recommended gifts based on one or more user profiles, the initial weighting, and attribute importance levels. The media guidance application may determine a weighting by using a purchase history, a viewing history, or a set of gift attribute preferences stored in the user profiles to modify the initial weighting. For example, the media guidance application may determine weighting based on the user profiles for both the first user and the second user to determine gifts they may enjoy together. As an alternate example, the media guidance application may combine together profiles from the second user, and other people who live in the household of the second user, to ensure that the recommended gift has not been purchased by anybody in the household. This may be particularly useful for larger purchases. For example, a grandparent may be interested in buying an expensive video game system for their young grandchild, and they want to ensure that nobody living in the household has already purchased the video game system. Alternately, the media guidance application may have access to sub-profiles or dummy profiles created by one user for another. For example, a wife may create a dummy profile for her husband, containing guesses about his demographic information, product and gift preferences, viewing and purchasing history, and the like. In some embodiments, the media guidance application may store these sub-profiles as part of the user profile for the first user. For example, a wife may create a sub-profile for her husband with a set of preferences and information that she has provided on his behalf. This profile may be combined with the husband's actual profile to generate gift recommendations.

In some embodiments, the media guidance application may determine a weighting based on multiple user profiles by evaluating each profile sequentially. For example, the media guidance application may use control circuitry 304 to employ a portion of process 1000, and determine a weighting based on a first user profile. The media guidance application may then use the weighting determined based on a first user profile as a new initial weighting, and employ a portion of process 1000 to determine a new weighting based on a second user profile.

In step 1114, the media guidance application ranks (e.g., via control circuitry 304 (FIG. 3)) the list of recommended gifts based on the determined weighting. For example, the media guidance application may sort (e.g., via control circuitry 304 (FIG. 3)) the list of recommended gifts by the determined weighting. The media guidance application may then assign the gift with the highest weighting rank 1, the gift with the next highest rating rank 2, and so on.

In step 1116, the media guidance application filters (e.g., via control circuitry 304 (FIG. 3)) the ranked list of recommended gifts based on the determined weighting. For example, the media guidance the application may remove (e.g., via control circuitry 304 (FIG. 3)) recommended gifts with a weighting below a threshold level. In some embodiments, the media guidance application may include gifts with a range of weightings, with a frequency based on the weighting. For example, the media guidance application may take a ranked list of gifts, and select all the gifts in the upper quartile, half the gifts in the second quartile, a fifth of the gifts in the third quartile, and no gifts from the bottom quartile.

In step 1118, the media guidance application presents (e.g., via control circuitry 304 (FIG. 3) and display 312 (FIG. 3)) part of the filtered list to a user in an order based on the rankings. For example, the media guidance application may present the filtered list by generating a display (e.g., display 312 (FIG. 3) on user equipment 402, 402 and/or 406 (FIG. 4)) with higher ranking gifts being features prominently. For instance, higher ranked gifts may be represented by larger icons, located towards a particular side of the screen, or featured in the center of the screen. In some embodiments, media guidance application may user speakers (e.g., speakers 314 (FIG. 3) on user equipment 402, 402 and/or 406 (FIG. 4)) to recite the list of gifts to the first user. In some embodiments the media guidance application may also store the list of gifts (e.g., on storage 308) and provide a user with an opportunity to retrieve the list at a later time.

It is contemplated that the steps or descriptions of FIG. 11 may be used with any other embodiment of this disclosure. In addition, the steps and descriptions described in relation to FIG. 11 may be done in alternative orders or in parallel to further the purposes of this disclosure. For example, performing steps in alternate order or in parallel may reduce the overall latency of the system, or allow a portion of the filtered list to be displayed constantly, with new items added and updated as more recommendations are retrieved and more weightings determined.

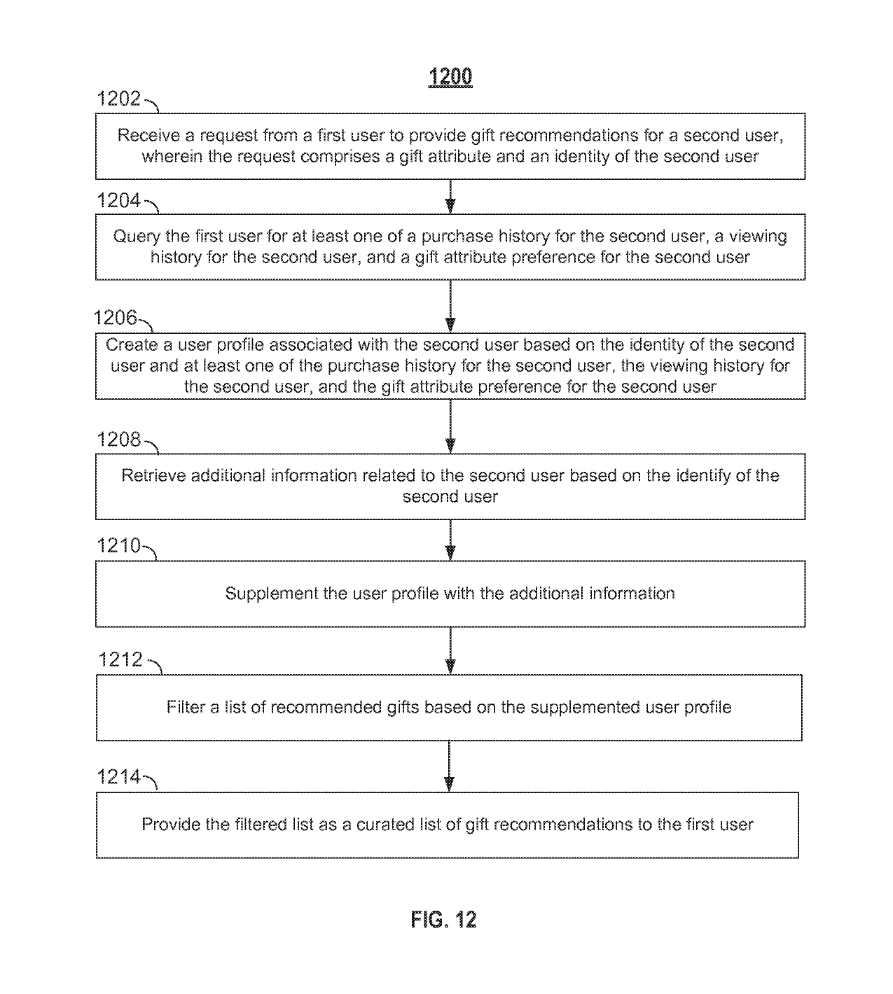

FIG. 12 is an illustrative block diagram of a method for providing a curated list of gift recommendations based on multiple user profiles and parsing a user request using natural language processing, in accordance with some embodiments of the disclosure. It should be noted that process 1200 or any step thereof could be performed on, or provided by, any of the devices shown in FIGS. 3-4. For example, process 1200 may be executed by control circuitry 304 (FIG. 3) as instructed by a media guidance application implemented on user equipment 402, 404, and/or 406 (FIG. 4). In addition, one or more steps of process 1200 may be incorporated into or combined with one or more steps of any other process or embodiment (e.g., algorithm 500 (FIG. 5), algorithm 600 (FIG. 6), algorithm 700 (FIG. 7), algorithm 800 (FIG. 8), process 900 (FIG. 9), process 1000 (FIG. 10), or process 1100 (FIG. 11)).

At step 1202, the media guidance application receives (e.g., via user input interface 310 (FIG. 3)) a request from a first user to provide gift recommendations for a second user, wherein the request comprises a gift attribute and an identity of the second user. For example, a first user, a gift giver, may wish to purchase a gift for the second user, a gift receiver. However, the first user may not know exactly what the second user would like. Accordingly, the first user may request gift recommendations for the second user.

At step 1204, the media guidance application queries (e.g., via control circuitry 304 (FIG. 3)) the first user for at least one of a purchase history for the second user, a viewing history for the second user, and a gift attribute preference for the second user. For example, the media guidance application may request the first user provide some information upon which the media guidance application may create a user profile for the second user.

For example, the media guidance application may request the first user provide a past purchase of the second user, a media asset that is enjoyed by the second user, and/or other information that may indicate one or more interests of the user.

At step 1206, the media guidance application creates (e.g., via control circuitry 304 (FIG. 3)) a user profile associated with the second user based on the identity of the second user and at least one of the purchase history for the second user, the viewing history for the second user, and the gift attribute preference for the second user. For example, the media guidance application may use information provided by the first user (e.g., information that the user knows about the likes and/or dislikes of the second user) to create a collection of data about the second user (i.e., a user profile). For example, as described above the media guidance application may compare attributes related to the information provided by the user to attributes about potential gifts in order to provide gift recommendations. In some embodiments, the media guidance application may store the collection of data about the second user in a sub-profile associated with both the first and the second users.

At step 1208, the media guidance application retrieves (e.g., from storage 308 (FIG. 3) and/or any location accessible via communications network 414 (FIG. 4)) additional information (e.g., information other than the information provided by the first user) related to the second user based on the identity of the second user. For example, the media guidance application may identify the second user by entering the name of the second user (e.g., provided by the first user) in a lookup table database (e.g., located at storage 308 (FIG. 3) and/or any location accessible via communications network 414 (FIG. 4)) to retrieve any other information that relates to the second user, and determine the identity of the second user. For example, the database may be populated with data from one or more sources (e.g., questionnaires submitted by the second user, industry data, demographic data, and/or information provided by third parties).

For example, the media guidance application may determine (e.g., via control circuitry 304 (FIG. 3)) a social network account associated with the second user and parse data on the social network account to determine additional information for the user profile. For example, the media guidance application may retrieve a list of entities such as friends (e.g., a social network buddy list), contacts (e.g., retrieved from a phone/text message/e-mail account associated with the user), and/or public services (e.g., hospitals, police departments, schools, etc.) with known associations to the user or the community of the user to search for information (e.g., a post, e-mail, etc.) created by the user. The media guidance application may then apply one or more object recognition techniques such as edge detection; pattern recognition, including, but not limited to, self-learning systems (e.g., neural networks); optical character recognition; on-line character recognition (including, but not limited to, dynamic character recognition, real-time character recognition, intelligent character recognition); and/or any other suitable technique to parse the information created by the second user. The media guidance application may then use the parsed information created by the user to learn interests or other information about the second user for use in providing gift recommendations.

As used herein, a “social network” refers to a platform that facilitates networking and/or social relations among people who, for example, share interests, activities, backgrounds, and/or real-life connections. In some cases, social networks may facilitate communication between multiple user devices (e.g., computers, televisions, smartphones, tablets, etc.) associated with different users by exchanging content from one device to another via a social media server. As used herein, a “social media server” refers to a computer server that facilitates a social network. For example, a social media server owned/operated/used by a social media provider may make content (e.g., status updates, microblog posts, images, graphic messages, etc.) associated with a first user accessible to a second user that is within the same social network as the first user. In such cases, classes of entities may correspond to the level of access and/or the amount or type of content associated with a first user that is accessible to a second user.

In another example, the media guidance application may determine a media provider account associated with the second user and retrieve a viewing history for the media provider account. For example, the media guidance application may access one or more streaming media providers and retrieve a user viewing history. Based on the user viewing history, the media guidance application may determine information (e.g., interests) about the second user for use in providing gift recommendations.

In yet another example, the media guidance application may determine an on-line retailer account associated with the second user and retrieve a purchase history for the on-line retailer account. For example, the media guidance application may access one or more e-commerce websites and retrieve a user purchase history. Based on the user purchase history, the media guidance application may determine information (e.g., interests) about the second user for use in providing gift recommendations.

In some embodiments, the media guidance application may verify that the additional information corresponds to the second user (e.g., by comparing the consistency of the information received from the first user and the additional information). For example, the media guidance application may compare the information provided by the first user to ensure that it is retrieving the correct additional information for the user profile for the second user.

Additionally or alternatively, the media guidance application may process privacy settings for the second user (e.g., located at storage 308 (FIG. 3) and/or any location accessible via communications network 414 (FIG. 4)) to determine what, if any, additional information may be used for the user profile. For example, the media guidance application may allow a second user to enter particular users, entities, etc. that may access one or more types of information. Before retrieving additional information, the media guidance application may check these settings to ensure it is authorized to use any retrieved information.

At step 1210, the media guidance application supplements (e.g., via control circuitry 304 (FIG. 3)) the user profile (e.g., located at storage 308 (FIG. 3) and/or any location accessible via communications network 414 (FIG. 4)) with the additional information. For example, in order to expand on the amount of information available to the media guidance application for determining gift recommendations, the media guidance application may supplement the information provided by the first user with the additional information. Using this broader base of information, the media guidance application may more narrowly tailor the gift recommendations to the user.

At step 1212, the media guidance application filters (e.g., via control circuitry 304 (FIG. 3)) a list of recommended gifts (e.g., located at storage 308 (FIG. 3) and/or any location accessible via communications network 414 (FIG. 4)) based on the supplemented user profile. For example, as discussed above, the media guidance application may retrieve, from a recommendation database, a list of recommended gifts and attributes describing each recommended gift. The media guidance application may determine a weighting for each of the recommended gifts based on a comparison with the supplemented user profile. The media guidance application may then rank the list of recommended gifts by their weighting, and select a predetermined number of top ranking recommended gifts to be included in the filtered list.

At step 1214, the media guidance application provides (e.g., via control circuitry 304 (FIG. 3)) the filtered list as a curated list of gift recommendations to the first user. In some embodiments, in order to ensure user privacy, the media guidance application may delete the supplemented user profile after providing the filtered list as the curated list of gift recommendations to the first user. For example, after using the information about the second user from various sources (including the first user), the media guidance application may delete the information to prevent further use of the information.

It is contemplated that the steps or descriptions of FIG. 12 may be used with any other embodiment of this disclosure. In addition, the steps and descriptions described in relation to FIG. 12 may be done in alternative order or in parallel to further the purposes of this disclosure. For example, performing steps in alternate order or in parallel may reduce the overall latency of the system, or allow a portion of the filtered list to be displayed constantly, with new items added and updated as more recommendations are retrieved and more weightings determined.

For illustrative purposes the examples given herein focus primarily on embodiments for providing gift recommendations to a single user based on a single attribute. However, the possible applications include, but are not limited to, providing recommendations for movie or video rentals for multiple users, providing recommendations for activities and services, finding gifts related to other gifts, or providing group gift recommendations. For example, the methods described could easily be adapted to a request that comprises an initial gift idea. By extracting attributes associated with the initial gift, the method could then proceed as described in detail above to produce additional curated gift recommendations. Or, as an alternate example, multiple users could contribute attributes, and the list of attributes may be used to recommend a collective gift to be given by the group to the second user. Additional, several embodiments are presented where the media guidance application may generate gift recommendations with limited access to user profile information. However, in principle, the media guidance application may be trusted with full access to user profile information provided the media guidance application does not divulge the profile contents to the first user. Finally, when using multiple sub-profiles or combining profiles together, rather than making a request for a gift recommendation that comprises a gift attribute, the request for a gift recommendation may comprise a profile, or a sub-profile. The list of recommended gifts may then be based directly on the information contained in the profile or the sub-profile. A second profile may then be used to filter the list of recommended gifts in order to provide a curated list of gift recommendations.

The above-described embodiments of the present disclosure are presented for the purposes of illustration and not of limitation, and the present disclosure is limited only by the claims that follow. Furthermore, it should be noted that the features and limitations described in any one embodiment may be applied to any other embodiment herein, and flowcharts or examples relating to one embodiment may be combined with any other embodiment in a suitable manner, done in different orders, or done in parallel. In addition, the systems and methods described herein may be performed in real-time. It should be noted, the systems and/or methods described above may be applied to, or used in accordance with, other systems and/or methods.

1. A method for providing curated lists of gift recommendations for users without querying the users or publicly disclosing information about the users, comprising:
receiving a request from a first user to provide gift recommendations for a second user, wherein the request comprises a gift attribute and an identity of the second user;
generating a database query from the gift attribute;
transmitting the generated query to a recommendation database, the database comprising a list of possible gifts and attributes describing each possible gift;
retrieving, from the recommendation database, a list of recommended gifts and attributes describing each recommended gift;
identifying a user profile associated with the second user based on the identity of the second user, wherein the user profile comprises at least one of a purchase history, a viewing history, and a gift attribute preference;
determining a weighting for each of the recommended gifts based on at least one of:
comparing the recommended gift with the purchase history of the second user;
comparing the attributes describing the recommended gift with the gift attribute preference of the second user;
comparing the attributes describing the recommended gift with attributes describing an item contained in the purchase history of the second user; and
comparing the attributes describing the recommended gift with attributes describing an item contained in the viewing history of the second user;
filtering the list of recommended gifts based on the determined weightings, wherein the filtering comprises removing recommended gifts with a weighting below a threshold from the list; and
providing the filtered list as a curated list of gift recommendations to the first user.

2. The method of claim 1, wherein the determining a weighting further comprises:
identifying an additional user profile associated with the first user, wherein the additional user profile comprises at least one of a purchase history and a viewing history;
determining a second weighting for each of the recommended gifts based on at least one of:
comparing the recommended gift with the purchase history of the first user;
comparing the attributes describing the recommended gift with attributes describing an item contained in the purchase history of the second user; and
comparing the attributes describing the recommended gift with attributes describing an item contained in the viewing history of the second user; and
modifying the determined weighting based on the second weighting.

3. The method of claim 1, wherein the identity of the second user comprises at least one of:
a name of the second user;
a pseudonym of the second user;
an image of the second user;
a location of the second user;
an event associated with the second user; and
a uniform resource locator associated with the second user.

4. The method of claim 1, wherein receiving a request further comprises:
receiving the request as a string of characters from the first user; and
generating the gift attribute by applying a natural language processing algorithm to the received string.

5. The method of claim 1, wherein generating a database query further comprises:
receiving a list of additional gift attributes, and a list of importance levels, wherein each element in the list of importance levels indicates a level of importance for at least one of the gift attribute and one of the additional gift attributes; and
generating the database query from the gift attribute, the list of additional gift attributes, and the list of importance levels.

6. The method of claim 1, wherein the comparing the attributes describing the recommended gift with the gift attribute preference of the second user comprises:
determining a preference level for one of the attributes describing the recommended gift based on the gift attribute preference of the second user; and
modifying the weighting based on the determined preference level.

7. The method of claim 1, wherein the comparing the attributes describing the recommended gift with attributes describing an item contained in the purchase history of the second user comprises:
identifying a first list comprising at least one of synonyms and antonyms for one of the attributes describing the recommended gift;
identifying a second list comprising at least one of synonyms and antonyms for one of the attributes describing the item contained in the purchase history of the second user;
comparing each item of the first list to each item of the second list; and
modifying the weighting based on the comparison.

8. The method of claim 1, wherein retrieving the list of recommended gifts comprises receiving an initial weighting for each of the recommended gifts, and wherein the determined weighting for each of the recommended gifts is based on the initial weighting.

9. The method of claim 1, wherein filtering the list of recommended gifts further comprises ranking the list of recommended gifts by their weighting, and selecting a predetermined number of top ranking recommended gifts to be included in the filtered list.

10. The method of claim 9, wherein providing the filtered list as a curated list of gift recommendations to the first user further comprises:
presenting part of the filtered list to the user in an order based on the ranking.

11. A system for providing curated lists of gift recommendations for users without querying the users or publicly disclosing information about the users, comprising:
user input circuitry configured to receive a request from a first user to provide gift recommendations for a second user, wherein the request comprises a gift attribute and an identity of the second user; and
control circuitry configured to:
generate a database query from a gift attribute;
transmit the generated query to a recommendation database, the database comprising a list of possible gifts and attributes describing each possible gift;
retrieve, from the recommendation database, a list of recommended gifts and attributes describing each recommended gift;
identify a user profile associated with the second user based on the identity of the second user, wherein the user profile comprises at least one of a purchase history, a viewing history, and a gift attribute preference;
determine a weighting for each of the recommended gifts based on at least one of:
comparing the recommended gift with the purchase history of the second user;
comparing the attributes describing the recommended gift with the gift attribute preference of the second user;
comparing the attributes describing the recommended gift with attributes describing an item contained in the purchase history of the second user; and
comparing the attributes describing the recommended gift with attributes describing an item contained in the viewing history of the second user;
filter the list of recommended gifts based on the determined weightings, wherein the filtering comprises removing recommended gifts with a weighting below a threshold from the list; and
provide the filtered list as a curated list of gift recommendations to the first user.

12. The system of claim 11, wherein the portion of the control circuitry configured to determine a weighting is further configured to:
identify an additional user profile associated with the first user, wherein the additional user profile comprises at least one of a purchase history and a viewing history;
determine a second weighting for each of the recommended gifts based on at least one of:
comparing the recommended gift with the purchase history of the first user;
comparing the attributes describing the recommended gift with attributes describing an item contained in the purchase history of the second user; and
comparing the attributes describing the recommended gift with attributes describing an item contained in the viewing history of the second user; and
modify the determined weighting based on the second weighting.

13. The system of claim 11, wherein the identity of the second user comprises at least one of:
a name of the second user;
a pseudonym of the second user;
an image of the second user;
a location of the second user;
an event associated with the second user; and
a uniform resource locator associated with the second user.

14. The system of claim 11, wherein
the user input circuitry is further configured to receive the request as a string of characters from the first user; and
the control circuitry is further configured to generate the gift attribute by applying a natural language processing algorithm to the received string.

15. The system of claim 11, wherein
the user input circuitry is further configured to:
receive a list of additional gift attributes, and a list of importance levels, wherein each element in the list of importance levels indicates a level of importance for at least one of the gift attribute and one of the additional gift attributes; and
generate the database query from the gift attribute, the list of additional gift attributes, and the list of importance levels.

16. The system of claim 11, wherein the portion of the control circuitry configured to compare the attributes describing the recommended gift with the gift attribute preference of the second user is further configured to:
determine a preference level for one of the attributes describing the recommended gift based on the gift attribute preference of the second user; and
modify the weighting based on the determined preference level.

17. The system of claim 11, wherein the portion of the control circuitry configured to compare the attributes describing the recommended gift with attributes describing an item contained in the purchase history of the second user is further configured to:
identify a first list comprising at least one of synonyms and antonyms for one of the attributes describing the recommended gift;
identify a second list comprising at least one of synonyms and antonyms for one of the attributes describing the item contained in the purchase history of the second user;
compare each item of the first list to each item of the second list; and
modify the weighting based on the comparison.

18. The system of claim 11, wherein
the portion of the control circuitry configured to retrieve the list of recommended gifts is further configured to receive an initial weighting for each of the recommended gifts; and
the portion of the control circuitry configured to determine a weighting is further configured to determined a weighting based on the initial weighting.

19. The system of claim 11, wherein the portion of the control circuitry configured to filter the list of recommended gifts is further configured to rank the list of recommended gifts by their weighting, and select a predetermined number of top ranking recommended gifts to be included in the filtered list.

20. The system of claim 19, wherein the portion of the control circuitry configured to provide the filtered list as a curated list of gift recommendations to the first user is further configured to:
present part of the filtered list to the user in an order based on the ranking.

21-50. (canceled)
